(19) United States
(12) Patent Application Publication
(10) Pub. No.: US 2026/0292382 A1
(43) Pub. Date: Sep. 24, 2026

(54) HEADPHONES

(71) Applicant: SHENZHEN SHOKZ CO., LTD., Shenzhen (CN)

(72) Inventors: Jianing LIANG, Shenzhen (CN); Lei ZHANG, Shenzhen (CN); Xin QI, Shenzhen (CN)

(73) Assignee: SHENZHEN SHOKZ CO., LTD., Shenzhen (CN)

(21) Appl. No.: 19/683,674

(22) Filed: May 20, 2026

Related U.S. Application Data
(63) Continuation of application No. 19/433,938, filed on Dec. 28, 2025.
Application No. 19/433,938 is a continuation of application No. PCT/CN2024/095605, filed on May 27, 2024.

(51) Int. Cl. H04R 1/10; H04R 1/02; H04R 1/22; H04R 9/02

(52) U.S. Cl. CPC H04R 1/10; H04R 1/02; H04R 1/22; H04R 9/025

(57) ABSTRACT

The present disclosure relates to a headphone, and specifically relates to the technical field of electronic devices. The headphone includes a first speaker and a second speaker. A frequency band of a sound output by the first speaker is at least partially lower than a frequency band of a sound output by the second speaker. The first speaker includes a first diaphragm and a first magnetic circuit system configured to drive the first diaphragm to produce the sound. The second speaker includes a second diaphragm and a second magnetic circuit system configured to drive the second diaphragm to produce the sound. A projection of the first magnetic circuit system in a vibration direction of the first diaphragm at least partially overlaps the second magnetic circuit system. The second magnetic circuit system and the first magnetic circuit system are arranged to repel each other.

### CROSS REFERENCE TO RELATED APPLICATIONS

This application is a continuation of U.S. patent application Ser. No. 19/433,938, filed on Dec. 28, 2025, which is a continuation of International Patent Application No. PCT/CN2024/095605, filed on May 27, 2024, the entire contents of which are incorporated herein by reference.

### TECHNICAL FIELD

The present disclosure generally relates to a field of electronic devices, and in particular to a headphone.

### BACKGROUND

With the development of acoustic technology, headphones have been widely used in people's daily lives. The headphones can use a combination of a plurality of speakers to output sound, offering users an immersive auditory experience. In such multi-driver configurations, different speakers may be respectively responsible for outputting sounds of different frequency bands. The coupling performance between the plurality of speakers is one of the important factors affecting the overall acoustic output effect of the headphone. Poor coupling among the speakers may lead to a degradation in sound quality.

### SUMMARY

One or more embodiments of the present disclosure provide a headphone. The headphone includes a first speaker and a second speaker. A frequency band of a sound output by the first speaker is at least partially lower than a frequency band of a sound output by the second speaker. The first speaker includes a first diaphragm and a first magnetic circuit system configured to drive the first diaphragm to produce the sound. The second speaker includes a second diaphragm and a second magnetic circuit system configured to drive the second diaphragm to produce the sound. A projection of the first magnetic circuit system in a vibration direction of the first diaphragm at least partially overlaps the second magnetic circuit system. The second magnetic circuit system and the first magnetic circuit system are arranged to repel each other.

### BRIEF DESCRIPTION OF THE DRAWINGS

To more clearly illustrate the technical solutions in the embodiments of the present disclosure, the drawings used in the description of the embodiments will be briefly introduced below. Obviously, the drawings in the following description are only some embodiments of the present disclosure. For those of ordinary skill in the art, other drawings may be obtained based on the drawings without creative effort.

FIG. 1 is a schematic diagram illustrating an exemplary headphone according to some embodiments of the present disclosure;

FIG. 2 is a schematic diagram illustrating the headphone in FIG. 1 from another perspective;

FIG. 3 is a schematic diagram illustrating the headphone in FIG. 1 from yet another perspective;

FIG. 4 is a schematic diagram illustrating a front contour of an ear of a user or a simulator according to some embodiments of the present disclosure;

FIG. 5 is a schematic diagram illustrating the headphone in FIG. 1 in a wearing state according to some embodiments of the present disclosure;

FIG. 6 is a cross-sectional view illustrating the headphone in FIG. 1 taken along line VI-VI according to some embodiments of the present disclosure;

FIG. 7 is a cross-sectional view illustrating the headphone in FIG. 1 taken along line VII-VII according to some embodiments of the present disclosure;

FIG. 8 is a schematic diagram illustrating a first housing in FIG. 6 according to some embodiments of the present disclosure;

FIG. 9 is a schematic diagram illustrating the first housing in FIG. 8 from another perspective;

FIG. 10 is a schematic diagram illustrating an arrangement of a first sound outlet and a second sound outlet in FIG. 9 according to some embodiments of the present disclosure;

FIG. 11 is a schematic diagram illustrating an arrangement of the first sound outlet and the second sound outlet in FIG. 10 according to some embodiments of the present disclosure;

FIG. 12 is another cross-sectional view illustrating the headphone in FIG. 1 taken along line VII-VII according to some embodiments of the present disclosure;

FIG. 13 is a schematic diagram illustrating the speaker assembly in FIG. 6 according to some embodiments of the present disclosure;

FIG. 14 is a circuit schematic diagram illustrating an exemplary speaker assembly according to some embodiments of the present disclosure;

FIG. 15 is a schematic diagram illustrating a correspondence relationship between a volume of a first front cavity and a resonant frequency of the first front cavity according to some embodiments of the present disclosure;

FIG. 16 is a schematic diagram illustrating the speaker assembly in FIG. 7 according to some embodiments of the present disclosure;

FIG. 17 is a schematic diagram illustrating cooperation between a second magnet, a third magnet, and a first speaker according to some embodiments of the present disclosure;

FIG. 18 is a schematic diagram illustrating an influence of a ratio of a cross-sectional area of the second magnet perpendicular to a vibration direction of a second diaphragm to a cross-sectional area of the third magnet perpendicular to the vibration direction of the second diaphragm on a magnetic flux density at a first coil in FIG. 17;

FIG. 19 is a schematic diagram illustrating the second speaker in FIG. 17 according to some embodiments of the present disclosure;

FIG. 20 is a schematic diagram illustrating the second speaker in FIG. 13 when moving in a long-axis direction CZ; and

FIG. 21 is a schematic diagram illustrating an influence of movement of the second speaker in FIG. 20 in the long-axis direction CZ on a magnetic flux density at a first coil.

### DETAILED DESCRIPTION

The present disclosure is further described in detail below with reference to the accompanying drawings and embodiments. It is specifically pointed out that the following embodiments are only used to illustrate the present disclosure, but do not limit the scope of the present disclosure. Similarly, the following embodiments are only some embodiments of the present disclosure rather than all embodiments. All other embodiments obtained by a person skilled in the art without creative efforts fall within the scope of the present disclosure.

Mention of “embodiment” in the present disclosure means that a specific feature, structure, or characteristic described in connection with the embodiment may be included in at least one embodiment of the present disclosure. A person skilled in the art explicitly and implicitly understands that the embodiments described in the present disclosure may be combined with other embodiments.

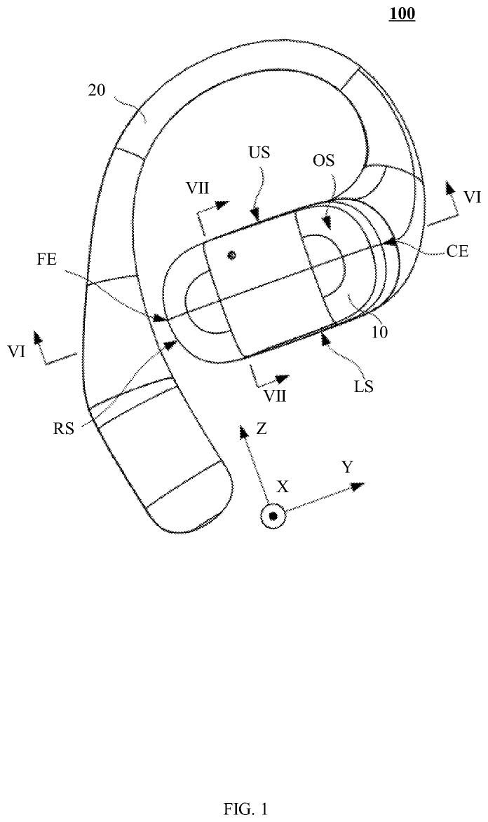

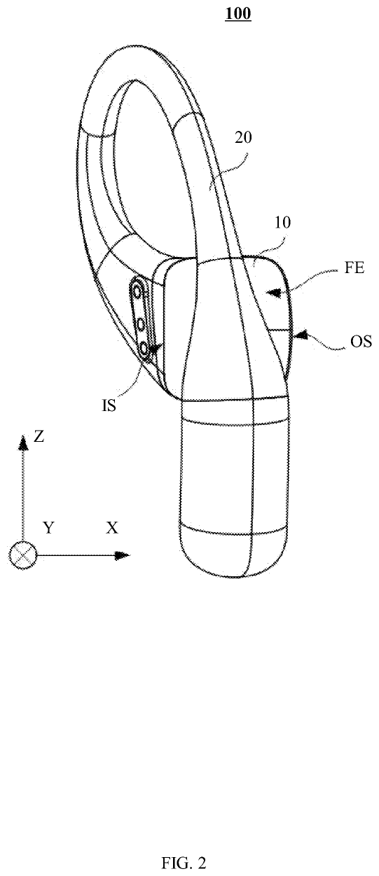

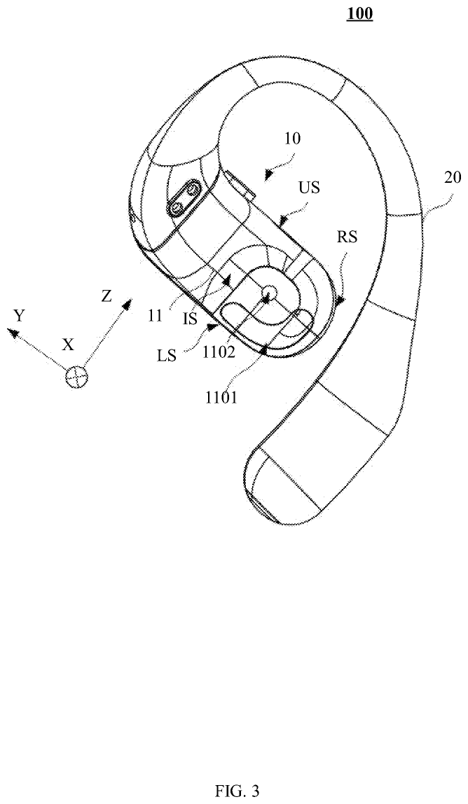

The present disclosure describes a headphone. Please refer to FIG. 1, FIG. 2, and FIG. 3, FIG. 1 is a schematic diagram illustrating an exemplary structure of a headphone according to some embodiments of the present disclosure; FIG. 2 is a schematic diagram illustrating the headphone in FIG. 1 from another perspective; and FIG. 3 is a schematic diagram illustrating the headphone in FIG. 1 from yet another perspective. The headphone 100 may include a core module 10 and an ear hook 20 connected to the core module 10. The core module 10 may provide a sound to achieve auditory experience. Certainly, the core module 10 may also have other functions, such as a sound pickup function, a touch function, a pressing function, or a lighting function, to achieve different experiences. The core module 10 may cooperate with the ear hook 20 to achieve wearing.

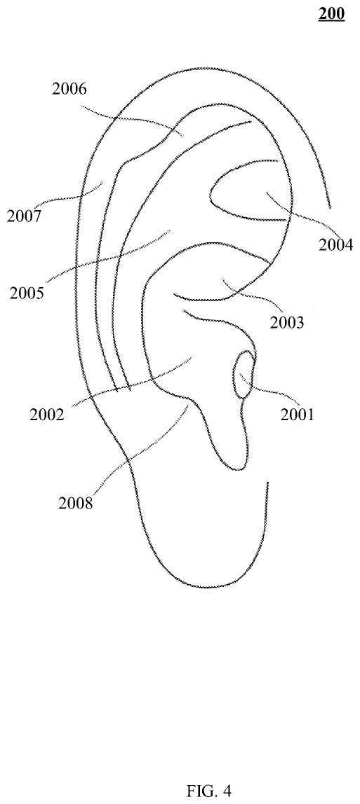

Please refer to FIG. 4, FIG. 4 is a schematic diagram illustrating a front contour of an ear of a user or a simulator according to some embodiments of the present disclosure. The ear 200 may include physiological portions such as an ear canal 2001, a concha cavity 2002, a concha cymba 2003, a triangular fossa 2004, an antihelix 2005, a scaphoid fossa 2006, a helix 2007, and an antitragus 2008. The ear canal 2001 includes a certain depth and may extend to an eardrum. However, for ease of description, the ear canal 2001 refers to an ear hole of the ear 200 unless otherwise specified in the present disclosure. Additionally, physiological portions such as the concha cavity 2002, the concha cymba 2003, and the triangular fossa 2004 may also have a certain volume and depth. The concha cavity 2002 may directly communicate with the ear canal 2001, that is, the ear hole may be considered to be located at a bottom of the concha cavity 2002.

It is understandable that there may be individual differences among different users, resulting in dimensional differences such as different shapes and sizes of the ear 200. For ease of description and to reduce (or even eliminate) individual differences among different users, a simulator including a head and ears 200 (generally including a left ear and a right ear, and one of the ears is taken as an example here) may be manufactured based on standards such as ANS: S3.36, S3.25, and IEC: 60318-7. For example, the simulator may be GRAS 45BC KEMAR, HEAD Acoustics, B&K 4128 series, or B&K 5128 series, to present a scenario where most users wear the headphone 100 through the simulator. Taking GRAS KEMAR as an example, the simulator of the ear 200 may be any one of GRAS 45AC, GRAS 45BC, GRAS 45CC, or GRAS 43AG. Taking HEAD Acoustics as an example, the simulator of the ear 200 may be any one of HMS II.3, HMS II.3 LN, or HMS II.3LN HEC.

It should be noted that in fields such as medicine and anatomy, three basic planes including a sagittal plane, a coronal plane, and a horizontal plane, and three basic axes including a sagittal axis, a coronal axis, and a vertical axis may be defined for a human body or the simulator of the human body. The sagittal plane refers to a plane perpendicular to the ground along an anteroposterior direction of the body, dividing the body into a left portion and a right portion. The coronal plane refers to a plane perpendicular to the ground along a medio lateral direction of the body, dividing the body into an anterior portion and a posterior portion. The horizontal plane refers to a plane parallel to the ground along a superior-inferior direction of the body, dividing the body into an upper portion and a lower portion. Correspondingly, the sagittal axis refers to an axis along the anteroposterior direction of the body and perpendicular to the coronal plane. The coronal axis refers to an axis along the medio lateral direction of the body and perpendicular to the sagittal plane. The vertical axis refers to an axis along the superior-inferior direction of the body and perpendicular to the horizontal plane. Furthermore, the front side of the ear described in the present disclosure is a concept relative to the rear side of the ear. The former refers to a side of the ear facing away from the head, the latter refers to a side of the ear facing towards the head, both are defined with respect to the ear 200 of the user or the simulator. When the ear 200 of the human body or the simulator of the human body is observed along the direction of the coronal axis, it may be as shown in FIG. 4.

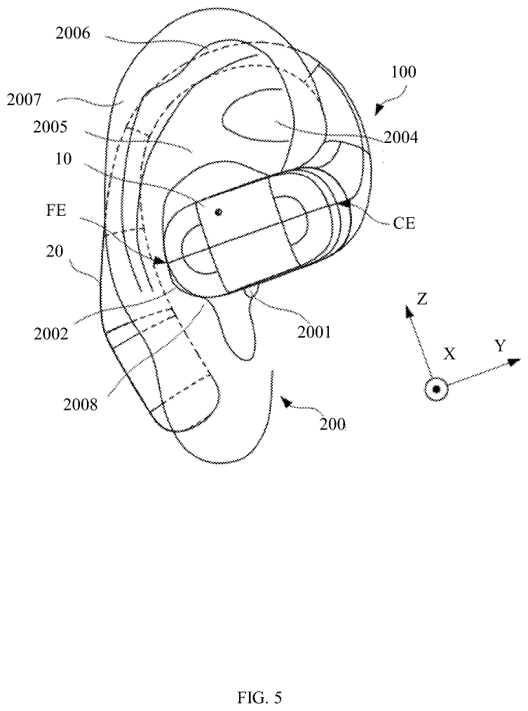

Please refer to FIG. 5, FIG. 5 is a schematic diagram illustrating the headphone 100 in FIG. 1 in a wearing state according to some embodiments of the present disclosure. The core module 10 is located on the front side of the ear 200 in the wearing state. At least a portion of the ear hook 20 is located on the rear side of the ear 200 in the wearing state, to make the headphone 100 hung on the ear 200 in the wearing state.

In the present disclosure, descriptions such as “wearing the headphone 100”, “the headphone 100 is in the wearing state”, and “in the wearing state” when describing a process or action of wearing the headphone 100 may all refer to the headphone 100 being worn on the ear 200. Certainly, precisely because individual differences exist among different users, there may be some differences between a situation when the headphone 100 is worn by different users and a situation when the headphone 100 is worn on the ear 200 of the simulator. However, the differences should be tolerable.

The core module 10 may be configured not to block the ear canal 2001 in the wearing state, to make the headphone 100 serve as an open headphone. It is understandable that in different wearing states, the core module 10 of the headphone 100 may partially cover the ear canal 2001, but the ear canal 2001 is still not blocked.

Please refer to FIG. 1, FIG. 2, and FIG. 3, the core module 10 may include a connection end CE connected to the ear hook 20 and a free end FE not connected to the ear hook 20. In the wearing state, the free end FE of the core module 10 may extend into the concha cavity 2002 or may only cover at least a portion of the concha cavity 2002. The core module 10 and the ear hook 20 may be configured to jointly clamp the ear 200 from front and rear sides of a region of the ear 200 corresponding to the concha cavity 2002, thereby increasing resistance of the headphone 100 to falling off from the ear 200 and thus improving stability of the headphone 100 in the wearing state.

The core module 10 may include a thickness direction X, and a longitudinal direction Y and a width direction Z that are perpendicular to the thickness direction X and orthogonal to each other. The longitudinal direction Y may be defined as a direction with a maximum extension dimension in a shape of a two-dimensional orthographic projection of the core module 10 on a plane where an outer side surface of the core module 10 is located (a two-dimensional projection plane) or on the sagittal plane (a two-dimensional projection plane). For example, when the shape of the two-dimensional orthographic projection is a rectangle or an approximate rectangle, the longitudinal direction Y is a longitudinal direction of the rectangle or the approximate rectangle. The width direction Z may be defined as a direction perpendicular to the longitudinal direction Y in the two-dimensional orthographic projection. For example, when the shape of the two-dimensional orthographic projection is a rectangle or an approximate rectangle, the width direction Z is a width direction of the rectangle or the approximate rectangle. The thickness direction X may be defined as a direction perpendicular to the two-dimensional projection plane carrying the two-dimensional orthographic projection.

In some embodiments, in the wearing state, when the core module 10 is in an inclined state, the longitudinal direction Y and the width direction Z are still parallel or approximately parallel to the sagittal plane. The longitudinal direction Y may include a non-0° angle with the sagittal axis, that is, the longitudinal direction Y may also be correspondingly inclined. The width direction Z may include a non-0° angle with the vertical axis, that is, the width direction Z is also inclined.

In some embodiments, the longitudinal direction Y may be defined as a direction in which the core module 10 is close to or away from the back of the head in the wearing state, that is, the longitudinal direction Y may be parallel to the sagittal axis or include a non-0° angle with the sagittal axis. The width direction Z may be defined as a direction in which the core module 10 is close to or away from the top of the head in the wearing state, that is, the width direction Z may be parallel to the vertical axis or include a non-0° angle with the vertical axis. In some embodiments, the free end FE presses against the concha cavity 2002 in the thickness direction X. As another example, the free end FE abuts against the concha cavity 2002 in at least one of the longitudinal direction Y or the width direction Z. In some embodiments, a direction from the connection end CE to the free end FE may be the longitudinal direction Y but may also be different from the longitudinal direction Y due to structural requirements.

It should be noted that in the wearing state, in addition to extending into the concha cavity 2002, the free end FE of the core module 10 may also include an orthographic projection falling on the antihelix 2005, or may include an orthographic projection falling on left and right sides of the head and at positions on the sagittal axis that are located at the front side of the ear 200.

Certainly, in other scenarios, at least a portion of the core module 10 may include an orthographic projection falling on the antihelix 2005, or may include an orthographic projection falling on the left and right sides of the head and at positions on the sagittal axis that are located at the front side of the ear 200.

In other words, the ear hook 20 may support the core module 10 to be worn at wearing positions such as the concha cavity 2002, the antihelix 2005, and the front side of the ear 200.

Please refer to FIG. 1, FIG. 2, and FIG. 5, in the wearing state and when observed along the direction of the coronal axis, the core module 10 may be configured as a circle, an ellipse, a rounded square, a rounded rectangle, or the like. Therefore, for ease of description, the present embodiment uses the core module 10 being configured as a rounded rectangle as an example for illustrative explanation. In some embodiments, the length of the core module 10 in the longitudinal direction Y may be greater than the width of the core module 10 in the width direction Z.

The core module 10 may include an inner side surface IS facing the ear 200 along the thickness direction X, an outer side surface OS facing away from the ear 200, and connecting surfaces (e.g., a lower side surface LS, an upper side surface US, an outer end surface RS, etc.) connecting the inner side surface IS and the outer side surface OS in the wearing state. When the core module 10 is in the wearing state, the upper side surface US connects the inner side surface IS and the outer side surface OS, the lower side surface LS connects the inner side surface IS and the outer side surface OS, the upper side surface US is closer to the top of the head of the user along the width direction Z, the lower side surface LS is farther from the top of the head of the user along the width direction Z, the outer end surface RS connects the upper side surface US and the lower side surface LS, and the outer end surface RS also connects the inner side surface IS and the outer side surface OS. The thickness direction X may also be defined as a direction in which the core module 10 approaches or moves away from the ear 200 in the wearing state. At least a portion of the connecting surfaces, for example, the outer end surface RS, is located in the concha cavity 2002 in the wearing state and forms a first contact region with an anterior region of the ear 200. That is, the outer end surface RS may be located at an end in the longitudinal direction Y facing the back of the head in the wearing state, and at least a portion thereof is located in the concha cavity 2002. In some embodiments, the ear hook 20 forms a second contact region with a posterior region of the ear 200 in the wearing state. The second contact region and the first contact region at least partially overlap in a thickness direction of the ear 200. Furthermore, the core module 10 and the ear hook 20 may clamp the ear 200 together from the front and rear sides of the ear 200, and a resulting clamping force is mainly manifested as compressive stress, which is conducive to improving the stability and comfort of the headphone 100 in the wearing state. In some embodiments, when the core module 10 is configured as a circle, an ellipse, or the like, the connecting surfaces may also refer to arc-shaped side surfaces of the core module 10.

It should be noted that the terms “first,” “second,” “third,” etc., in the present disclosure are used for descriptive purposes only and are not to be construed as indicating or implying relative importance or implicitly specifying the quantity of the indicated technical features. Thus, features defined by terms such as “first,” “second,” “third,” etc., may explicitly or implicitly include at least one such feature. In the description of the present disclosure, the meaning of “a plurality of” is at least two, for example, two, three, etc., unless explicitly and specifically defined otherwise.

It is understandable that the core module 10 may also be worn directly or through other means or may even be connected and cooperate with other structures in coordination with the ear hook 20 to achieve wearing. Furthermore, when implementing the function of the core module 10, it is not limited to the embodiments listed in the present disclosure. In some embodiments, the ear hook 20 may be omitted or replaced with other structures.

Additionally, when a wearing manner of the core module 10 changes, a cooperation manner between the core module 10 and the ear 200 may also change, but in some embodiments, the change does not necessarily cause changes to an internal structure, overall construction, an external structure, etc., of the core module 10. Even in some embodiments, directional terms such as the lower side surface LS, the upper side surface US, and the outer end surface RS, etc., may not necessarily correspond to the ear 200. Certainly, in some embodiments, terms such as the connection end CE may merely become directional terms and do not necessarily imply the inclusion of a specific function.

Furthermore, when the wearing manner of the core module 10 changes, the core module 10 may not cooperate with the ear hook 20 or other structures at the connection end CE to achieve wearing.

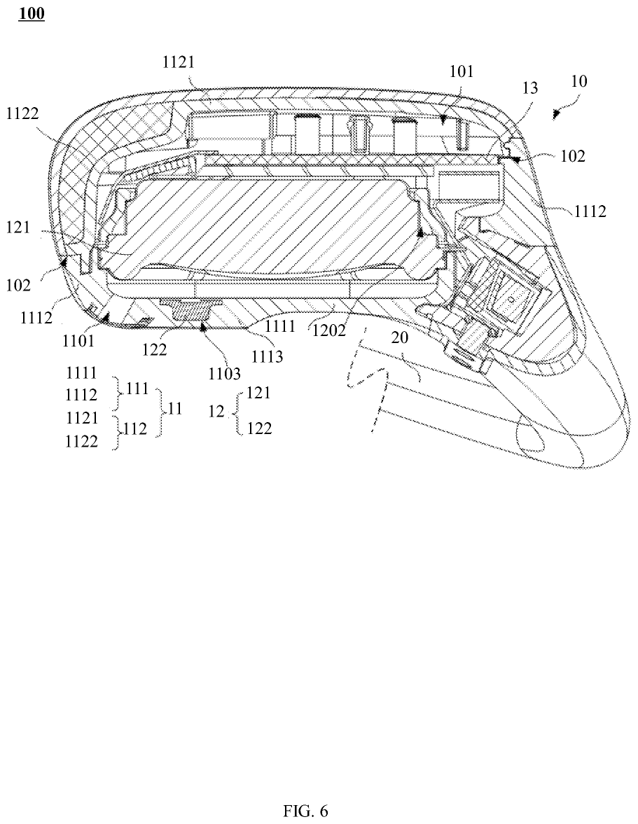

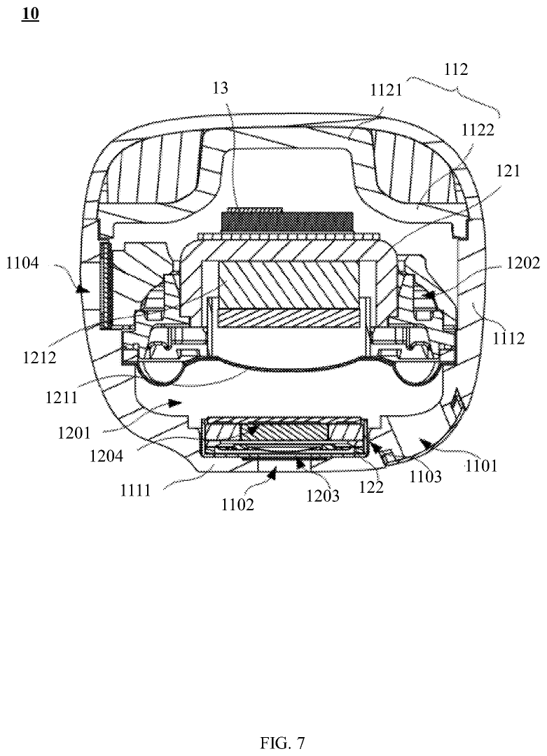

Please refer to FIG. 6 and FIG. 7, FIG. 6 is a cross-sectional view illustrating the headphone in FIG. 1 taken along line VI-VI according to some embodiments of the present disclosure, and FIG. 7 is a cross-sectional view illustrating the headphone in FIG. 1 taken along line VII-VII according to some embodiments of the present disclosure. The core module 10 may include a core housing 11, a speaker assembly 12, and a main control circuit board 13. The core housing 11 may be connected to the ear hook 20. The core housing 11 may include a mounting space 101 for mounting the speaker assembly 12 and the main control circuit board 13. In some embodiments, the mounting space 101 may also be used for mounting other electronic elements, which will not be elaborated here. The speaker assembly 12 and the main control circuit board 13 may be disposed in the core housing 11, for example, in mounting space 101. The main control circuit board 13 may be electrically connected to the speaker assembly 12 and is configured to control operation of the speaker assembly 12. It is understandable that the core housing 11 serves as an external housing of the core module 10, the inner side surface IS, the outer side surface OS, and the connecting surfaces (e.g., the lower side surface LS, the upper side surface US, and the outer end surface RS) connecting the inner side surface IS and the outer side surface OS of the core module 10 are all formed on the core housing 11, serving as an outer side surface of the core housing 11.

The core housing 11 may include a first housing 111 and a second housing 112 that are engaged with each other along the thickness direction X to form mounting space 101. The first housing 111 is closer to the ear 200 than the second housing 112 in the wearing state. Parting surfaces 102 are provided between the first housing 111 and the second housing 112 to simplify the structure of the core housing 11 and reduce processing costs. In some embodiments, the core housing 11 may also have other structural forms and is not limited to the embodiments listed in the present disclosure.

In some embodiments, the core housing 11 is provided with a first sound outlet 1101 and a second sound outlet 1102 for communicating with the mounting space 101. The first sound outlet 1101 and the second sound outlet 1102 may cooperate with the speaker assembly 12 respectively, to make sound waves generated by the speaker assembly 12 propagate through the first sound outlet 1101 and the second sound outlet 1102 respectively. The first sound outlet 1101 and the second sound outlet 1102 are not connected to each other. Providing two sound outlets can improve the auditory experience of the speaker assembly 12 and avoid sound wave interference between a plurality of speakers.

Please refer to FIG. 8, FIG. 8 is a schematic diagram illustrating the first housing 111 in FIG. 6 according to some embodiments of the present disclosure. In some embodiments, at least one of the first sound outlet 1101 or the second sound outlet 1102 may be provided on the first housing 111. For example, both the first sound outlet 1101 and the second sound outlet 1102 may be provided on a bottom wall 1111 of the first housing 111. In some embodiments, the bottom wall 1111 may correspond to the inner side surface IS of the core module 10. When a wearing manner where the core module 10 extends into the concha cavity 2002 is adopted, since the concha cavity 2002 includes a certain volume and depth, after the free end FE extends into the concha cavity 2002, a portion of the inner side surface IS corresponding to the bottom wall 1111 of the core housing 11 may have a certain distance from the concha cavity 2002. Furthermore, in the wearing state, the core housing 11 and the concha cavity 2002 may cooperate to form an auxiliary cavity communicating with the ear canal 2001. The first sound outlet 1101 and the second sound outlet 1102 are at least partially opposite to and communicate with the auxiliary cavity. Furthermore, in the wearing state, sound waves generated by the speaker assembly 12 and propagating through the first sound outlet 1101 and the second sound outlet 1102 are confined by the auxiliary cavity. That is, the auxiliary cavity may concentrate the sound waves, allowing more sound waves to propagate into the ear canal 2001, thereby increasing the volume and quality of a sound heard by the user in a near field, which is conductive to improving an acoustic effect of the headphone 100.

In some embodiments, both the first sound outlet 1101 and the second sound outlet 1102 are closer to the free end FE than to the connection end CE, to make that the first sound outlet 1101 and the second sound outlet 1102 are closer to the ear canal 2001 in the wearing state. In some embodiments, the core module 10 may be configured not to block the ear canal in the wearing state, and the auxiliary cavity may be configured as semi-open.

Please refer to FIG. 7 and FIG. 8, the first housing 111 may be a plastic component, or may be a structure composed of or compounded from a plurality of materials. In some embodiments, the first housing 111 may be a housing structure made of other materials. The first housing 111 may include a first side wall 1112 extending from an edge of the bottom wall 1111 toward a side close to the second housing 112. In some embodiments, the first side wall 1112 may be provided with at least one of a pressure relief hole 1104 or a tuning hole 1105, that is, at least one of the pressure relief hole 1104 or the tuning hole 1105 may be provided on the upper side surface US or the lower side surface LS corresponding to the core housing 11. Furthermore, at least one of the pressure relief hole 1104 or the tuning hole 1105 may be provided with an acoustic resistance net, a protective steel net, or the like.

Understandably, positions of acoustic holes such as the pressure relief hole 1104 and the tuning hole 1105 may be adjusted on the core housing 11, e.g., on the first housing 111, according to requirements of a person skilled in the art. For example, the pressure relief hole 1104 and the tuning hole 1105 may be respectively provided on opposite sides of the first side wall 1112 along the width direction Z.

Additionally, since the first sound outlet 1101, the pressure relief hole 1104, and the tuning hole 1105 may all be provided on the first housing 111, a structure of the first housing 111 is simpler, which is conductive to reduce processing costs. Furthermore, since the pressure relief hole 1104 and the tuning hole 1105 are respectively provided on opposite sides of the first side wall 1112 along the width direction Z, the parting surfaces 102 may be disposed approximately symmetrically about a reference plane perpendicular to the width direction Z, which is conductive to improving an appearance quality of the core module 10.

Moreover, the acoustic holes are not limited to the pressure relief hole 1104 and the tuning hole 1105 and may also include other acoustic holes cooperating with the speaker assembly 12. In some embodiments, at least one of the pressure relief hole 1104 and the tuning hole 1105 may be omitted.

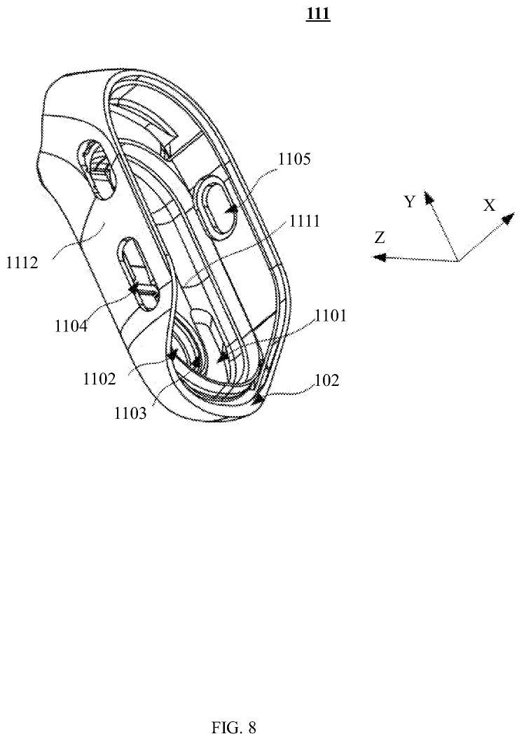

Please refer to FIG. 9, FIG. 9 is a schematic diagram illustrating the first housing 111 in FIG. 8 from another perspective. The first sound outlet 1101 and the second sound outlet 1102 are disposed adjacent to each other. A rational layout of the sound outlets ensures that, in the wearing state, volumes of sounds output from the first sound outlet and the second sound outlet are balanced, thereby enhancing the listening experience of the user. In some embodiments, the first sound outlet 1101 may be disposed to surround a periphery of the second sound outlet 1102, to further improve sound magnetism of the speaker assembly 12. Certainly, compared to the first sound outlet 1101 disposed in a straight line, the first sound outlet 1101 disposed in a surrounding manner is more conducive to achieving a sufficient total opening area for the sound outlet within a limited space on the first housing 111, thereby ensuring consistency in sound perception across different users.

In some embodiments, a protruding portion 1113 protruding in the thickness direction X may be provided on the inner side surface IS of the core housing 11 (e.g., on the bottom wall 1111 corresponding to the inner side surface IS). The second sound outlet 1102 may be on the protruding portion 1113. A portion of the speaker assembly 12 may be accommodated inside the protruding portion 1113, to make that in the wearing state, the portion of the speaker assembly 12 accommodated in the protruding portion 1113 is closer to the ear canal of the user. A sound path of the sound waves generated by the speaker assembly 12 and transmitted out through the second sound outlet 1102 to the ear canal 2001 becomes shorter, reducing loss of the sound waves and increasing a sound pressure level in the ear canal 2001. In some embodiments, the first sound outlet 1101 may also be on the protruding portion 1113. The first sound outlet 1101 may be closer to or directly face the concha cavity 2002 via the protruding portion 1113, to make the sound output from the first sound outlet 1101 be reflected and enhanced by physiological portions such as the concha cavity 2002. In some embodiments, the first sound outlet 1101 may be disposed to surround a periphery of the protruding portion 1113, making the structure of the core housing 11 more compact. Meanwhile, in the wearing state, the sound path difference between sounds transmitted via the first sound outlet 1101 and the second sound outlet 1102 respectively to reach the ear canal 2001 of the user is small, ensuring listening consistency.

In some embodiments, the protruding portion 1113 protrudes and extends in a direction away from the inner side surface IS compared to other regions on the inner side surface IS of the core housing 11 (e.g., on the bottom wall 1111 corresponding to the inner side surface IS). In other embodiments, the protruding portion 1113 may also be provided on the lower side surface LS or other connecting surfaces of the aforementioned core housing 11 to adapt to different wearing scenarios.

In some embodiments, a cross-sectional area of the protruding portion 1113 perpendicular to the thickness direction X may gradually decrease along a direction away from the core housing 11.

Please refer to FIG. 9, the first sound outlet 1101 may include a first hole section 1114 and a second hole section 1115. In some embodiments, the first hole section 1114 and the second hole section 1115 may be on the inner side surface IS. Please refer to FIG. 9, the first hole section 1114 is located at the side of the second sound outlet 1102 close to the lower side surface LS. The second hole section 1115 is located at a side of the second sound outlet 1102 close to the outer end surface RS. With such an arrangement, in the wearing state (e.g., when the free end FE of the core module 10 extends into the concha cavity 2002), the first sound outlet 1101 is closer to the ear canal 2001 of the user, to make more sound output from the core module 10 be transmitted into the ear canal 2001 of the user, ensuring a listening volume. As another example, the first hole section 1114 is located at the side of the second sound outlet 1102 close to the lower side surface LS. The second hole section 1115 is located at a side of the second sound outlet 1102 away from the outer end surface RS. The arrangement prevents the formation of the second hole section 1115 from adversely affecting the wearing experience of the user.

In some embodiments, the first hole section 1114 may also be provided at a corner where the inner side surface IS connecting to the lower side surface LS. The second hole section 1115 may be provided at a corner where the inner side surface IS connecting to the outer end surface RS. In the wearing state (e.g., when a portion of the core module 10 abuts against the antihelix 2005), the first sound outlet 1101 may be directed toward the ear canal 2001 of the user, improving sound directivity and enhancing the listening volume. In other embodiments, the first hole section 1114 may be on the inner side surface IS, and the second hole section may be provided at the corner where the inner side surface IS connecting to the outer end surface RS. In some embodiments, the first hole section 1114 may be on a connecting surface between the inner side surface IS and the lower side surface LS (e.g., at the corner where the inner side surface IS connecting to the lower side surface LS). In some embodiments, the second hole section 1115 is on a connecting surface between the inner side surface IS and the outer end surface RS (e.g., at the corner where the inner side surface IS connecting to the outer end surface RS).

In some embodiments, the first hole section 1114 extends from a connection with the second hole section 1115 along the longitudinal direction Y, and a width thereof in the width direction Z is in a range of 1 mm-2.5 mm. The second hole section 1115 extends from a connection with the first hole section 1114 along the width direction Z, and a width thereof in the longitudinal direction Y is in a range of 1 mm-2.5 mm. In some embodiments, the first hole section 1114 extends from the connection with the second hole section 1115 along the longitudinal direction Y, and the width thereof in the width direction Z gradually decreases. Meanwhile, the second hole section 1115 extends from the connection with the first hole section 1114 along the width direction Z, and the width thereof in the longitudinal direction Y gradually increases. With such an arrangement, sound wave interference between the first hole section 1114, which is closer to the lower side surface LS or the upper side surface US, and other acoustic holes provided on the lower side surface LS or the upper side surface US can be avoided, ensuring an air permeability of the first sound outlet 1101 and avoiding impact on the listening of the user.

In some embodiments, the pressure relief hole 1104 may be on the upper side surface US. In some embodiments, the pressure relief hole 1104 may also be on the lower side surface LS. Additionally, when the pressure relief hole 1104 cooperates with the first sound outlet 1101, mutual influence between the pressure relief hole 1104 and the first sound outlet 1101 (e.g., the first hole section 1114 and the second hole section 1115) is reduced.

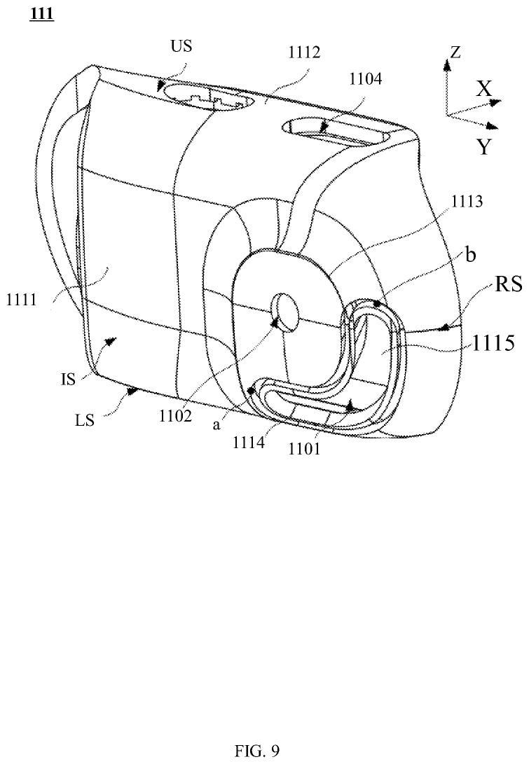

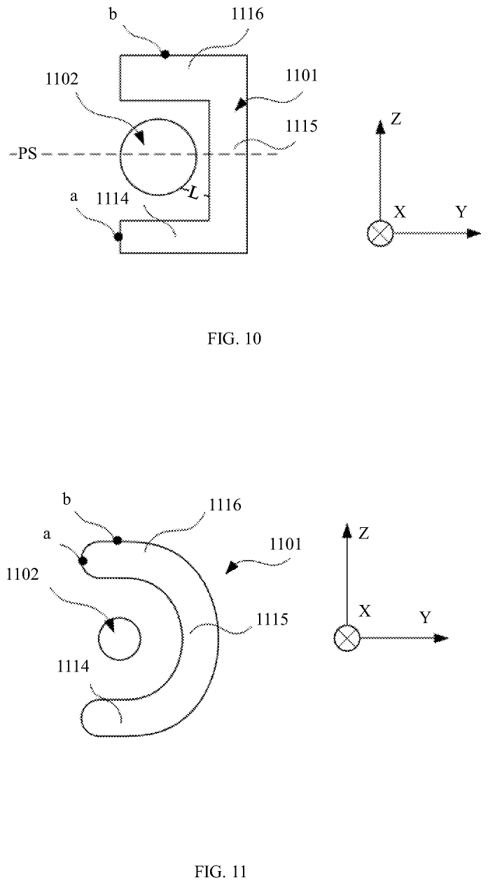

In some embodiments, the first sound outlet 1101 may further include a third hole section 1116. Please refer to FIG. 10 and FIG. 11, FIG. 10 is a schematic diagram illustrating an arrangement of the first sound outlet 1101 and the second sound outlet 1102 in FIG. 9 according to some embodiments of the present disclosure, and FIG. 11 is a schematic diagram illustrating an arrangement of the first sound outlet 1101 and the second sound outlet 1102 in FIG. 10 according to some embodiments of the present disclosure. The third hole section 1116 may be connected to the end of the second hole section 1115 away from the first hole section 1114, and is located at a side of the second sound outlet 1102 away from the first hole section 1114. In some embodiments, the third hole section 1116 may be on the inner side surface IS and located at a side of the second sound outlet 1102 close to the upper side surface US. In this case, the first hole section 1114 is located at a side of the second sound outlet 1102 close to the lower side surface LS. That is, the third hole section 1116 is in communication with the second hole section 1115 and is located at opposite sides of the second sound outlet 1102 from the first hole section 1114, to make the second hole section 1115 connect the first hole section 1114 and the third hole section 1116 to form an integrated structure. In some embodiments, the third hole section 1116 may be provided at a corner where the inner side surface IS connecting to the upper side surface US. In some embodiments, the third hole section 1116 may be on a connecting surface between the inner side surface IS and the upper side surface US (e.g., at the corner where the inner side surface IS connecting to the upper side surface US).

In some embodiments, provision of the third hole section 1116 allows the first sound outlet 1101 to be symmetrical about the longitudinal direction Y, possessing a symmetry plane PS disposed along the longitudinal direction Y, which causes the first sound outlet 1101 to form a “U-shaped” structure with its opening facing away from the outer end surface RS.

In other embodiments, the third hole section 1116 is provided at a side of the second sound outlet 1102 away from the outer end surface RS, and the third hole section 1116 is connected to an end of the first hole section 1114 away from the second hole section 1115. In this case, the first sound outlet 1101 has a “U-shaped” structure with an opening facing the upper side surface US. In other embodiments, the first hole section 1114 is located at a side of the second sound outlet 1102 close to the upper side surface US, the third hole section 1116 is provided at a side of the second sound outlet 1102 away from the outer end surface RS, and the third hole section 1116 is connected to the end of the first hole section 1114 away from the second hole section 1115. In this case, the first sound outlet 1101 has a “U-shaped” structure with an opening facing the lower side surface LS.

Please refer to FIG. 9, FIG. 10, and FIG. 11, along the longitudinal direction Y, a distance from a reference point a on a hole edge of the first sound outlet 1101 farthest from the free end FE to the outer end surface RS is not less than 9 mm. It should be understood that when the outer end surface RS is an arc surface and there exists a tangent plane, which is drawn at a reference point on the outer end surface RS that is farthest from the connection end CE along the longitudinal direction Y and perpendicular to the longitudinal direction Y, a distance from the reference point a to the tangent plane along the longitudinal direction Y is not less than 9 mm. In some embodiments, along the longitudinal direction Y, the distance from the reference point a on the hole edge of the first sound outlet 1101 farthest from the free end FE to the outer end surface RS is in a range of 10 mm-20 mm. With such an arrangement, a layout of the first sound outlet 1101 on the core housing 11 can be optimized, ensuring an air permeability of the first sound outlet 1101.

In some embodiments, along the width direction Z, a distance from a reference point b on the hole edge of the first sound outlet 1101 closest to the upper side surface US to the upper side surface US may be not less than 1.5 mm. It should be understood that when the upper side surface US is an arc surface and there exists a tangent plane, which is drawn at a reference point on the upper side surface US that is farthest from the lower side surface LS along the width direction Z and perpendicular to the width direction Z, a distance from the reference point b to the tangent plane along the width direction Z is not less than 1.5 mm. In some embodiments, along the width direction Z, the distance from the reference point b on the hole edge of the first sound outlet 1101 closest to the upper side surface US to the upper side surface US is in a range of 2 mm-8 mm. With such an arrangement, the layout of the first sound outlet 1101 on the core housing 11 can be optimized, avoiding interference between sound waves emitted from the first sound outlet 1101 and sound waves emitted from other acoustic holes on the upper side surface US, and ensuring the listening effect of the user.

Please refer to FIG. 10 and FIG. 11, the first sound outlet 1101 and the second sound outlet 1102 may be approximately arranged on a plane perpendicular to the thickness direction X. In some embodiments, on the plane perpendicular to the thickness direction X, a shortest distance L between a hole edge of an orthographic projection of the first sound outlet 1101 and a hole edge of an orthographic projection of the second sound outlet 1102 may constrain a relative positional relationship between the first sound outlet 1101 and the second sound outlet 1102. In some embodiments, the shortest distance L between the hole edge of the orthographic projection of the first sound outlet 1101 and the hole edge of the orthographic projection of the second sound outlet 1102 is not less than 2 mm, thereby avoiding sound wave interference between sound waves transmitted from the first sound outlet 1101 and the second sound outlet 1102 respectively, and affecting the listening effect of the user. In some embodiments, the shortest distance L between the hole edge of the orthographic projection of the first sound outlet 1101 and the hole edge of the orthographic projection of the second sound outlet 1102 is in a range of 2 mm-5 mm, which avoids acoustic interference while ensuring that the first sound outlet 1101 includes a sufficient ventilation area.

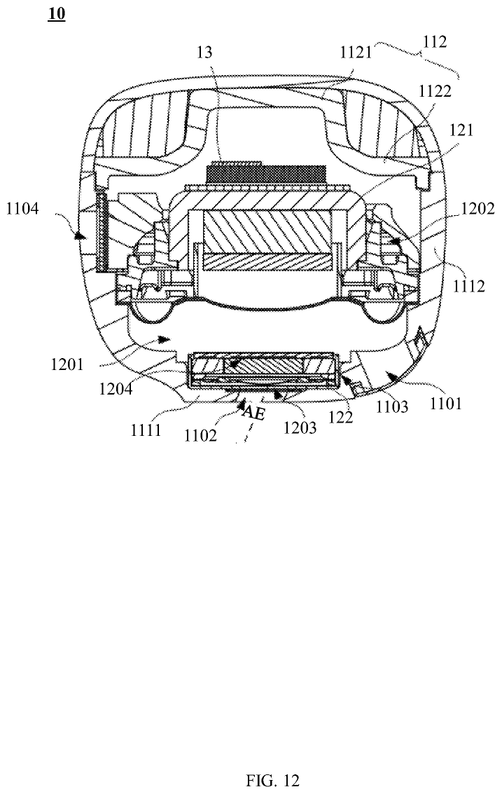

Please refer to FIG. 12, FIG. 12 is another cross-sectional view illustrating the headphone in FIG. 1 taken along line VII-VII according to some embodiments of the present disclosure. The second sound outlet 1102 may include a central axis AE. A direction of the central axis AE away from the core housing 11 may be a positive direction. In some embodiments, an extension direction of the second sound outlet 1102 may be the central axis AE. In some embodiments, a line connecting a centroid of an opening surface of the second sound outlet 1102 on the inner side surface IS and a centroid of an opening surface on an internal surface within the mounting space 101 of the core housing 11 may also be referred to as the central axis AE. In some embodiments, the central axis AE of the second sound outlet 1102 may be perpendicular to a side surface (e.g., the inner side surface IS) of the core housing 11 where the second sound outlet is located. In some embodiments, the positive direction of the central axis AE of the second sound outlet 1102 is set to form an angle of less than 90° with the side surface (e.g., the inner side surface IS) of the core housing 11 where the second sound outlet is located, which allows the second sound outlet 1102 to be more biased towards the ear canal 2001, thereby improving the listening effect of the user. For example, when the second sound outlet is on the inner side surface IS of the core housing 11, the positive direction of the central axis AE of the second sound outlet 1102 may be inclined towards the upper side surface US, the lower side surface LS, or the outer end surface RS. In some embodiments, an angle between the positive direction of the central axis AE of the second sound outlet 1102 and a positive direction of the width direction Z is in a range of 75° to 80°. The positive direction of the width direction Z may point from the upper side surface US to the lower side surface LS.

In some embodiments, please refer to FIG. 9, FIG. 10, and FIG. 11, a dimension of the first sound outlet 1101 in the longitudinal direction Y is in a range of 6 mm to 8 mm, and a dimension of the first sound outlet 1101 in the width direction Z is in a range of 5 mm to 7 mm. The configuration ensures that the first sound outlet 1101 includes a sufficient ventilation area and a resonant frequency of a speaker cavity coupled to the first sound outlet 1101 is within an ideal range.

Please refer to FIG. 6, FIG. 7, and FIG. 8, a recessed region 1103 is formed on the inner wall of the core housing 11 to engage with the speaker assembly 12, which improves spatial utilization within the core housing 11 (e.g., the mounting space 101), and additionally facilitates the positioning of the speaker assembly 12. In some embodiments, the recessed region 1103 may be disposed around a periphery of the second sound outlet 1102, to make a space within the recessed region 1103 be in communication with the second sound outlet 1102. In some embodiments, the recessed region 1103 may be disposed corresponding to the protruding portion 1113. That is, the recessed region 1103 is disposed on a side of the protruding portion 1113 facing the interior of the core housing 11 (e.g., the mounting space 101). In this case, at least a portion of the speaker assembly 12 may be disposed within the recessed region 1103.

Please refer to FIG. 6, the second housing 112 may be a plastic component, or may be a structure composed of or compounded from a plurality of materials. In some embodiments, the second housing 112 may also be a housing structure made of other materials. The parting surfaces 102 between the second housing 112 and the first housing 111 (e.g., the first side wall 1112) extends or bends towards the first housing 111 in a direction approaching the free end FE. The second housing 112 may include a top wall 1121 disposed opposite to the first housing 111 (e.g., the bottom wall 1111), and a second side wall 1122 connected to the top wall 1121 and engaged with the first housing 111 (e.g., the first side wall 1112).

It is understandable that, due to the configuration of the second side wall 1122, the free end FE is tapered in a direction away from the connection end CE, which facilitates cooperation with the contour of the ear of the user, thereby improving the wearing experience.

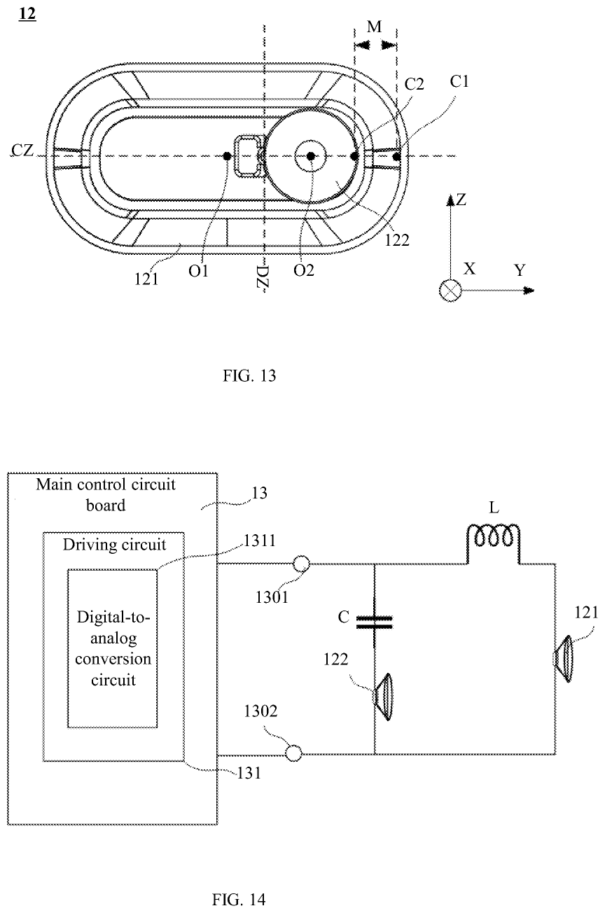

Please refer to FIG. 6, FIG. 7, and FIG. 13, FIG. 13 is a schematic diagram illustrating the speaker assembly 12 in FIG. 6 according to some embodiments of the present disclosure. The speaker assembly 12 may convert a received electrical signal into a sound signal (a sound wave). The sound wave may be propagated through at least one of the first sound outlet 1101 or the second sound outlet 1102 to facilitate entry into the ear canal 2001. The speaker assembly 12 may be coupled to the main control circuit board 13 to allow operation under control of the main control circuit board 13. The speaker assembly 12 may include a first speaker 121 and a second speaker 122 disposed within the core housing 11 (e.g., the mounting space 101). The first speaker 121 and the second speaker 122 may be respectively coupled to the main control circuit board 13 to allow operation under control of the main control circuit board 13. A sound wave generated by the first speaker 121 may be propagated through the first sound outlet 1101. A sound wave generated by the second speaker 122 may be propagated through the second sound outlet 1102. In some embodiments, the sound wave generated by the first speaker 121 and the sound wave generated by the second speaker 122 may also be propagated through other acoustic holes on the core housing 11 (e.g., the pressure relief hole 1104 and the tuning hole 1105).

In some embodiments, the sound wave generated by the first speaker 121 may be propagated through the first sound outlet 1101 (e.g., the first hole section 1114 and the second hole section 1115). The sound wave generated by the second speaker 122 may be propagated through the second sound outlet 1102. In some embodiments, the sound wave generated by the first speaker 121 may also be propagated through the third hole section 1116.

A frequency range of a sound output by the first speaker 121 is at least partially lower than a frequency range of a sound output by the second speaker 122. In some embodiments, the frequency range of the sound output by the first speaker 121 may be entirely less than the frequency range of the sound output by the second speaker 122. In other embodiments, the frequency range of the sound output by the first speaker 121 partially overlaps with the frequency range of the sound output by the second speaker 122, and a maximum frequency of the sound output by the first speaker is lower than a maximum frequency of the sound output by the second speaker. The arrangement allows a frequency band of the sound output by the second speaker 122 to be partially greater than a frequency band of the sound output by the first speaker 121.

In some embodiments, the frequency range of the sound output by the first speaker 121 may include 20 Hz to 5 kHz. The frequency range of the sound output by the second speaker 122 may include 5 kHz to 20 kHz. In some embodiments, the frequency range of the sound output by the first speaker 121 and the frequency range of the sound output by the second speaker 122 may include different standards based on actual situations. For example, the frequency range of the sound output by the first speaker 121 may also refer to a frequency range not exceeding 1 kHz, e.g., 1 Hz to 1 kHz, 100 Hz to 800 Hz, etc.

In some embodiments, the frequency range of the sound output by the first speaker 121 may be referred to as a low frequency band or a mid-low frequency band. The frequency range of the sound output by the second speaker 122 may be referred to as a high frequency band or a mid-high frequency band. Accordingly, the first speaker 121 may be referred to as a low-frequency speaker, and the second speaker 122 may be referred to as a high-frequency speaker. The low frequency band may be at least a portion of a frequency band substantially from 20 Hz to 500 Hz, or at least a portion of a frequency band substantially from 20 Hz to 3 kHz. The high frequency band may be at least a portion of a frequency band substantially from 5 kHz to 20 kHz, or at least a portion of a frequency band from 6 kHz to 16 kHz. A mid frequency band may be between the low frequency band and the high frequency band, and may partially overlap with at least one of the low frequency band or the high frequency band. Accordingly, the mid-low frequency band may be a combination of the low frequency band and the mid frequency band. The mid-high frequency band may be a combination of the mid frequency band and the high frequency band.

It is understandable that above distinctions of the frequency bands are merely given as approximate intervals by way of example. The definitions of the frequency bands may vary depending on different industries, different application scenarios, and different classification standards. For example, in some other application scenarios, the low frequency band refers to a frequency band substantially from 20 Hz to 80 Hz, the mid-low frequency band may refer to a frequency band substantially from 80 Hz to 160 Hz, the mid frequency band may refer to a frequency band substantially from 160 Hz to 1280 Hz, the mid-high frequency band may refer to a frequency band substantially from 1280 Hz to 2560 Hz, and the high frequency band may refer to a frequency band substantially from 2560 Hz to 120 kHz.

Please refer to FIG. 6 and FIG. 7, the first speaker 121 may be fixed within the core housing 11. An axial direction of the first speaker 121 may be along the thickness direction X. In some embodiments, the first speaker 121 may be fixed to the first housing 111 (e.g., the bottom wall 1111), or be fixed to the first side wall 1112 or other portions of the core housing 11. In some embodiments, the axial direction of the first speaker 121 may be a vibration direction of the first diaphragm 1211.

In some embodiments, the first speaker 121 may include a strip-like structure to conform to the core housing 11 (e.g., the mounting space 101). That is, the first speaker 121 extends in a direction from the connection end CE to the free end FE. The configuration allows for a sufficiently large first speaker 121 to be housed within the core housing 11 (e.g., the mounting space 101), thereby enhancing the volume of the sound generated by the headphone 100 by optimizing the layout and improving space utilization.

Please refer to FIG. 7, the first speaker 121 may include the first diaphragm 1211 for vibrating to produce a sound, a first magnetic circuit system 1212 for driving the first diaphragm 1211 to vibrate and produce the sound, and a support member for carrying the first diaphragm 1211 and the first magnetic circuit system 1212. Within the understanding of those skilled in the art, the technical principle of how the first magnetic circuit system 1212 drives the first diaphragm 1211 to vibrate and produce the sound through the cooperation of a first coil and a magnet will not be elaborated here.

The first speaker 121 is disposed within the core housing 11 (e.g., within the mounting space 101) and cooperates with the core housing 11 to form a first front cavity 1201 located at a front side of the first diaphragm 1211 and a first rear cavity 1202 located at a rear side of the first diaphragm 1211. The front side of the first diaphragm 1211 refers to a side of the first diaphragm 1211 away from the first magnetic circuit system 1212. The rear side of the first diaphragm 1211 refers to a side of the first diaphragm 1211 towards the first magnetic circuit system 1212. In some embodiments, the first front cavity 1201 is located at a side of the first speaker 121 facing the inner side surface IS of the core housing 11, e.g., facing the bottom wall 1111 of the first housing 111. The first rear cavity 1202 is located at a side of the first speaker 121 away from the inner side surface IS, e.g., away from the bottom wall 1111 of the first housing 111. In some embodiments, the first front cavity 1201 is in communication with the first sound outlet 1101, to make a sound wave generated by the cooperation of the first speaker 121 and the first front cavity 1201 be propagated through the first sound outlet 1101. The first rear cavity 1202 may be coupled to other acoustic holes on the core housing 11 (e.g., the pressure relief hole 1104 and the tuning hole 1105), to make a sound wave generated by the cooperation of the first speaker 121 and the first rear cavity 1202 be propagated through the other acoustic holes.

The second speaker 122 is disposed within the core housing 11. Please refer to FIG. 6 and FIG. 7, the second speaker 122 may be fixed to the first housing 111 (e.g., the bottom wall 1111). In this case, an axial direction of the second speaker 122 may be along the thickness direction X. In some embodiments, the second speaker 122 may be located in the first front cavity 1201 of the first speaker 121. In this case, the axial direction of the first speaker 121 is parallel to the axial direction of the second speaker 122. In other embodiments, the second speaker 122 may also be fixed on the first side wall 1112 or other portions of the core housing 11. In other embodiments, the second speaker 122 may not be located in the first front cavity 1201 based on setting requirements. Furthermore, the axial direction of the second speaker 122 may also be set to intersect with the thickness direction X.

In some embodiments, the second speaker 122 may be embedded in an inner wall of the core housing 11. For example, a groove may be provided on the inner wall of the core housing 11 to accommodate the second speaker 122, thereby achieving an embedded configuration of the second speaker 122. Please refer to FIG. 7, a groove (e.g., the recessed region 1103) for accommodating the second speaker 122 may be provided on the bottom wall 1111 of the first housing 111. In this case, in the wearing state, the second speaker 122 is located at the inner wall of the inner side surface IS of the core module 10 and closer to the ear of the user. As another example, the groove for accommodating the second speaker 122 may be provided on the lower side surface of the core module 10 or on the inner wall of each connecting surface to adapt to different wearing scenarios and provide a better auditory experience for the user.

Please refer to FIG. 14, FIG. 14 is a circuit schematic diagram illustrating an exemplary speaker assembly according to some embodiments of the present disclosure. The speaker assembly 12 may include a first connection end 1301 and a second connection end 1302 electrically connected to the main control circuit board 13, respectively. The first speaker 121 may be connected in series between the first connection end 1301 and the second connection end 1302, and thus may produce the sound under the control of the main control circuit board 13. The second speaker 122 may be connected in series between the first connection end 1301 and the second connection end 1302, and thus may produce the sound under the control of the main control circuit board 13.

As described above, the first front cavity 1201 and the first rear cavity 1202 of the first speaker 121 are coupled to the first sound outlet 1101 and other acoustic holes (e.g., the pressure relief hole 1104) on the core housing 11, respectively. Since the first front cavity 1201 and the first rear cavity 1202 are located at two sides of the first diaphragm 1211, the sound waves output therefrom are naturally out of phase. Consequently, the sound waves from the first front cavity 1201 and the first rear cavity 1202 may undergo destructive interference in a far field, thereby reducing sound leakage from the headphone 100. However, when a frequency band of a sound output is high, a wavelength of a sound within the high frequency band is short. Under far-field conditions, the first front cavity 1201 and the first rear cavity 1202 are equivalent to two sound sources. A distance between the two sound sources becomes significant relative to the wavelength, preventing sound signals from canceling out. Additionally, when an acoustic transmission structure of the headphone 100 resonates, there is a certain phase difference between an actual phase of a sound signal radiated by the first front cavity 1201 and the first rear cavity 1202 and an original phase at a sound generation position. The resonance also introduces additional peaks in a transmitted sound wave, resulting in a chaotic sound field distribution. Consequently, it becomes difficult to maintain effective far-field leakage cancellation at high frequencies, and leakage may even be increased.

Therefore, it is necessary to process the sound within a high frequency band output by the first speaker 121 to avoid significant far-field sound leakage within the higher frequency band. Accordingly, some embodiments of the present disclosure can enable the first speaker 121 to only output sounds in a low frequency band. Within the low frequency band, phases of the sound waves generated by the first speaker 121 are substantially unaffected by a cavity structure (e.g., the first front cavity 1201 and the first rear cavity 1202), allowing the phases to cancel each other out in the far field and reduce far-field sound leakage. Simultaneously, the second speaker 122 may be dedicated to outputting a sound within a high frequency band. Leveraging the strong directivity exhibited by the high frequency band, the sound within the high frequency band primarily towards the ear canal 2001 of the user, thereby minimizing leakage. The approach ultimately ensures that the headphone 100 achieves the sound leakage reduction effect across the full frequency band.

In some embodiments, the first front cavity 1201 may include a first resonant frequency. The first rear cavity 1202 may include a second resonant frequency.

Merely by way of example, a test manner for the first resonant frequency may be as follows: positioning a test instrument (e.g., a microphone) close to and directly facing the headphone 100 (e.g., the first sound outlet 1101 coupled to the first front cavity 1201) according to measurement manners and standards well-known to those skilled in the art, exciting the headphone 100 via a signal generator (e.g., the main control board 13) to complete a test, obtaining a frequency response curve related to the first front cavity 1201, and then obtaining the first resonant frequency by analyzing the frequency response curve.

Furthermore, a test manner for the second resonant frequency may be as follows: positioning a test instrument (e.g., a microphone) close to and directly facing the headphone 100 (e.g., acoustic holes coupled to the first rear cavity 1202 such as the pressure relief hole 1104) according to measurement manners and standards well-known to those skilled in the art, exciting the headphone 100 via a signal generator (e.g., the main control board 13) to complete a test, obtaining a frequency response curve related to the first rear cavity 1202, and then obtaining the second resonant frequency by analyzing the frequency response curve.

It is understandable that a distance between the test instrument (e.g., the microphone) and the headphone 100 (e.g., acoustic holes such as the first sound outlet 1101 and the pressure relief hole 1104) is determined according to requirements of the measurement manners and standards well-known to those skilled in the art. In some embodiments, the distance may also be defined as being less than a preset distance threshold (e.g., 5 cm).

The first front cavity 1201 and the first sound outlet 1101 may be approximated as a Helmholtz resonator model, where the first front cavity 1201 serves as a cavity of the Helmholtz resonator model, and the first sound outlet 1101 acts as a neck of the Helmholtz resonator model. In this case, a resonance frequency of the Helmholtz resonator model is the first resonant frequency of the first front cavity 1201. In the Helmholtz resonator model, a volume of the first front cavity 1201 may affect the first resonant frequency f of the first front cavity 1201. A specific relationship is as follows:

$$f = \frac{c}{2 π} \sqrt{\frac{s}{VL}} \qquad ( 1 )$$

where c denotes a speed of the sound in air, S denotes a sound outlet area (also referred to as a cross-sectional area) of the neck (e.g., the first sound outlet 1101), V denotes the volume of the cavity (e.g., the first front cavity 1201), and L denotes a depth of the neck (e.g., the first sound outlet 1101).

As derived from formula (1), the first resonant frequency f may be adjusted by altering the sound outlet area S of the first sound outlet 1101 or the volume V of the first front cavity 1201. For example, with other conditions held constant, an increase in the volume of the first front cavity 1201 causes the first resonant frequency f to shift toward lower frequencies. Similarly, the first rear cavity 1202 and its coupled acoustic hole may also be approximately as a Helmholtz resonator model, and the second resonant frequency may be adjusted accordingly, which will not be repeated here.

In some embodiments, the second resonant frequency may be less than the first resonant frequency, and a difference between the first resonant frequency and the second resonant frequency may not exceed 1000 Hz. With such an arrangement, the sounds transmitted to the outside by the first front cavity 1201 and the first rear cavity 1202 can better cancel each other out in the far field, reducing sound leakage of the headphone and enhancing the privacy experience of the user. For example, a range of the first resonant frequency is 4.5 kHz-5.5 kHz, and a range of the second resonant frequency is 4 kHz-5 kHz.

In some embodiments, a first resonant peak of the first front cavity 1201 may be adjusted by adjusting the volume of the first front cavity 1201. In other words, increasing the volume of the first front cavity 1201 causes the first resonant peak of the first front cavity 1201 to shift toward the lower frequency band. This is because, at a frequency band beyond the resonant frequency, a sound pressure level (SPL) produced by the cavity undergoes a rapid attenuation. Consequently, as the first resonant frequency of the first front cavity 1201 shifts lower, sound waves within the high frequency band generated by the first speaker 121 experience greater attenuation, which results in the first speaker 121 outputting only the sounds within the low frequency band, while the sounds with the high frequency band are reproduced almost entirely by the second speaker 122. With such an arrangement, the ideal sound leakage reduction effect across the full frequency band can be achieved for the headphone.

In some embodiments, the volume of the first front cavity 1201 may be adjusted to be within a range of 270 mm³ to 400 mm³. By limiting the volume of the first front cavity 1201, the first resonant frequency of the first front cavity 1201 shifts towards the low frequency band, thereby attenuating the sound waves with the high frequency band generated by the first speaker 121. That is, the low-pass filtering is achieved by adjusting the volume of the first front cavity 1201. In some embodiments, the volume of the first front cavity 1201 may be in a range of 290 mm³ to 350 mm³. In some embodiments, the volume of the first front cavity 1201 may be 300 mm³ or 310 mm³. It is understandable that the design of the volume of the first front cavity 1201 aims to attenuate the sound waves within the high frequency band generated by the first speaker 121. Accordingly, the volume of the first front cavity 1201 may also be adjusted according to the needs of those skilled in the art.

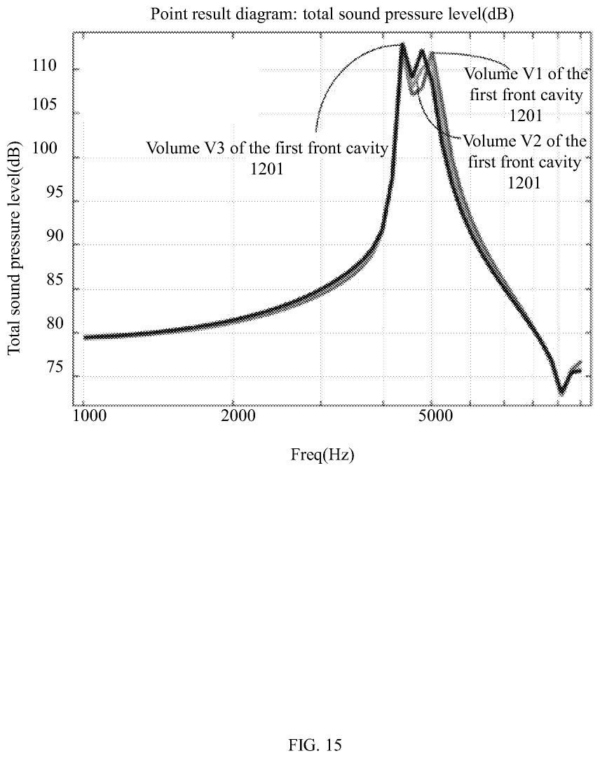

Please refer to FIG. 15, FIG. 15 is a schematic diagram illustrating a correspondence relationship between a volume of the first front cavity 1201 and a resonant frequency of the first front cavity 1201 according to some embodiments of the present disclosure. Volume V1 is 270 mm³, volume V2 is 310 mm³, and volume V3 is 350 mm³. V1, V2, and V3 correspond to a cavity frequency response curve, respectively. During a process that the volume of the first front cavity 1201 increases from 270 mm³ to 350 mm³, from the curve corresponding to volume V1, the curve corresponding to volume V2, and the curve corresponding to volume V3, it may be seen that the first resonant frequency of the first front cavity 1201 decreases from 5.1 kHz to 4.8 kHz. It may be seen that as the volume of the first front cavity 1201 increases, the first resonant frequency of the first front cavity 1201 shifts towards lower frequencies.

It is understandable that, shifting the first resonant frequency of the first front cavity 1201 to the lower frequency band is not limited to defining the volume of the first front cavity 1201, which may also be achieved through the design of a position or shape of the first sound outlet 1101, as described in the aforementioned embodiments (e.g., FIGS. 9, 10, and 11).

In some embodiments, the second speaker 122 may include a third resonant frequency. In some embodiments, the third resonant frequency of the second speaker 122 may be not less than 5.5 kHz. Therefore, when cooperating with the first speaker 121, after the sound waves within the high frequency band generated by the first speaker 121 are attenuated, additional sound waves within the high frequency band may be effectively supplemented by the second speaker 122, without affecting the overall sound quality of the headphone 100. In some embodiments, the third resonant frequency of the second speaker 122 may be not less than 6 kHz. In some embodiments, the third resonant frequency of the second speaker 122 may be in a range of 6 kHz-10 kHz.

In some embodiments, the difference between the third resonant frequency and the first resonant frequency and a difference between the third resonant frequency and the second resonant frequency are not less than 2000 Hz. Therefore, when cooperating with the first speaker 121, after the sound waves within the high frequency band generated by the first speaker 121 are attenuated, additional sound waves within the high frequency band may be effectively supplemented by the second speaker 122, without affecting the overall sound quality of the headphone 100. In some embodiments, the difference between the third resonant frequency and the first resonant frequency and the difference between the third resonant frequency and the second resonant frequency are not less than 2500 Hz.

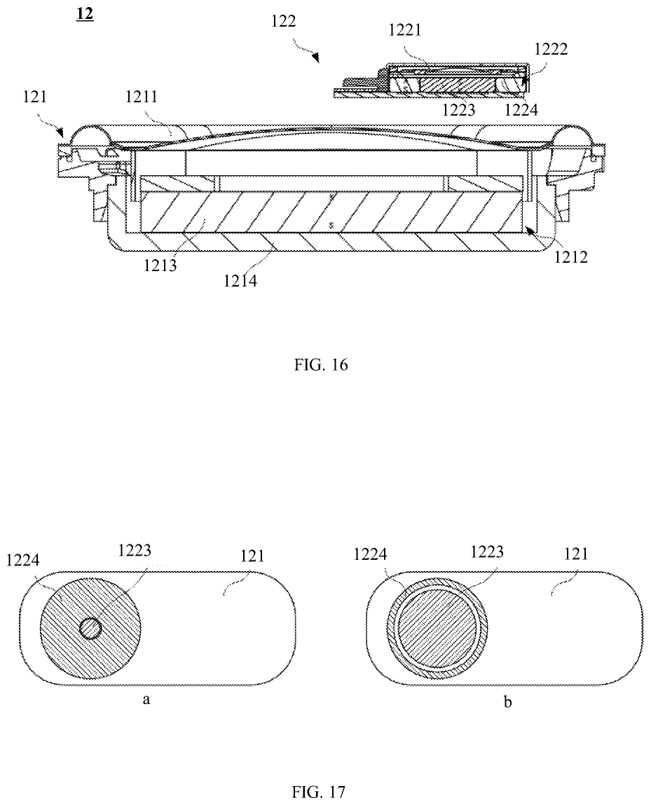

Please refer to FIG. 7 and FIG. 16, FIG. 16 is a schematic diagram illustrating the speaker assembly 12 in FIG. 7 according to some embodiments of the present disclosure. The second speaker 122 may include a second diaphragm 1221 for vibrating to produce a sound, a second magnetic circuit system 1222 for driving the second diaphragm 1221 to produce the sound, and a speaker housing for carrying and mounting the second diaphragm 1221 and the second magnetic circuit system 1222. Within the scope understood by those skilled in the art, the technical principle of how the second magnetic circuit system 1222 drives the second diaphragm 1221 to vibrate and produce the sound through cooperation of a second coil and a magnet is not described again. The speaker housing is a housing structure different from the core housing 11, to make the second speaker 122 be flexibly mounted on the core module 10. A portion of the speaker housing may be integrally formed with the core housing 11, and another portion may include a support frame to carry the second speaker 122, thereby making the structure of the core module 10 more simpler.

The second speaker 122 is located in the core housing 11 (e.g., in the mounting space 101) and cooperates with the core housing 11. The front side of the second diaphragm 1221 of the second speaker 122 cooperates with the speaker housing to form a second front cavity 1203. A rear side of the second diaphragm 1221 cooperates with the speaker housing to form a second rear cavity 1204. The front side of the second diaphragm 1221 refers to a side of the second diaphragm 1221 away from the second magnetic circuit system 1222. The rear side of the second diaphragm 1221 refers to a side of the second diaphragm 1221 facing the second magnetic circuit system 1222. When the second speaker is located on an inner wall of the core module 10 corresponding to the inner side surface IS, the second front cavity 1203 is located on a side of the second speaker 122 facing the inner side surface IS, and the second rear cavity 1204 is located on a side of the second speaker 122 away from the inner side surface IS.

The second front cavity 1203 may be in communication with the second sound outlet 1102, to make the sound waves generated by the second speaker 122 be transmitted through the second sound outlet 1102. In some embodiments, the first front cavity 1201 and the second front cavity 1203 may be in communication with each other, to make both the first sound outlet 1101 and the second sound outlet 1102 be in communication with the first front cavity 1201 or the second front cavity 1203. In other embodiments, the core housing 11 may also include a structure such as an isolation plate disposed between the second speaker 122 and the first speaker 121 to isolate a cavity coupled to the first speaker 121 from a cavity coupled to the second speaker 122, which makes that the first sound outlet 1101 only in communication with the first front cavity 1201, and the second sound outlet 1102 only in communication with the second front cavity 1203.

In some embodiments, the second speaker 122 may be mounted in the core housing 11 at a position closer to the free end FE. That is, the length of the second speaker 122 in a direction from the connection end CE to the free end FE is less than a length of the first speaker 121 in the direction from the connection end CE to the free end FE. With such an arrangement, in the wearing state (e.g., a state where the free end FE extends into the concha cavity 2002), the second speaker 122 is close to the free end FE, to make the sound output from the second sound outlet 1102 be better transmitted to the ear canal of the user, thereby increasing a listening volume.

In some embodiments, the second magnetic circuit system 1222 and the first magnetic circuit system 1212 are arranged to repel each other, to enhance a magnetic flux density at the first coil in the first speaker 121. The repelling arrangement may be understood as follows. A magnetic pole of the second magnetic circuit system 1222 facing the first magnetic circuit system 1212 is an N pole, and a magnetic pole of the first magnetic circuit system 1212 facing the second magnetic circuit system 1222 is an N pole. As a result, the second magnetic circuit system 1222 exerts a force on the first magnetic circuit system 1212, causing the first magnetic circuit system 1212 to move away from the second magnetic circuit system 1222, while the first magnetic circuit system 1212 exerts a force on the second magnetic circuit system 1222, causing the second magnetic circuit system 1222 to move away from the first magnetic circuit system 1212. As another example, the magnetic pole of the second magnetic circuit system 1222 facing the first magnetic circuit system 1212 is an S pole, and the magnetic pole of the first magnetic circuit system 1212 facing the second magnetic circuit system 1222 is an S pole. It is understandable that the second magnetic circuit system 1222 and the first magnetic circuit system 1212 may also be arranged to repel each other to increase the magnetic flux density at the second coil, which is not described again herein.

In some embodiments, due to the increase in the magnetic flux density at the first coil or the second coil, a driving force of the first coil driving the first diaphragm 1211 and a driving force of the second coil driving the second diaphragm 1221 are enhanced, thereby increasing the sound pressure levels of the sound waves output by both the first speaker 121 and the second speaker 122. In some embodiments, a repulsion degree between the second magnetic circuit system 1222 and the first magnetic circuit system 1212 may be configured such that the sound pressure level of the second speaker 122 is increased by at least 1 dB compared to when the second speaker 122 operates alone (e.g., without the first speaker 121 as described in the above embodiments). In some embodiments, the repulsion degree between the second magnetic circuit system 1222 and the first magnetic circuit system 1212 may be configured such that the sound pressure level of the second speaker 122 is increased by at least 2 dB compared to when the second speaker 122 operates alone.

Similarly, in some embodiments, the repulsion degree between the second magnetic circuit system 1222 and the first magnetic circuit system 1212 may be configured such that the sound pressure level of the first speaker 121 is increased by at least 1 dB compared to when the first speaker 121 operates alone (e.g., without the second speaker 122 in the above embodiments). In some embodiments, the repulsion degree between the second magnetic circuit system 1222 and the first magnetic circuit system 1212 may be configured such that the sound pressure level of the first speaker 121 is increased by 2 dB compared to when the first speaker 121 exists alone.

The repulsive cooperation between the second magnetic circuit system 1222 and the first magnetic circuit system 1212 may increase the sound pressure level of at least one of the first speaker 121 or the second speaker 122. Consequently, while maintaining the sound pressure level of the sound output from the headphone 100 through the repulsive cooperation between the second magnetic circuit system 1222 and the first magnetic circuit system 1212, a relative distance between the second speaker 122 and the first speaker 121 may be reduced, which allows for a more compact design of the headphone 100, making the headphone 100 lighter and smaller, thereby improving the wearing experience of the user. In some embodiments, the distance between the second speaker 122 and the first speaker 121 may be reduced to 2 mm.

In some embodiments, a projection of the second magnetic circuit system 1222 along a vibration direction of the second diaphragm 1221 may at least partially overlap with the first magnetic circuit system 1212, to ensure the repulsion degree between the second magnetic circuit system 1222 and the first magnetic circuit system 1212, and enhance the magnetic flux density at the first coil or the second coil. In some embodiments, a projection of the first magnetic circuit system 1212 along a vibration direction of the first diaphragm 1211 at least partially overlaps with the second magnetic circuit system 1222, to ensure the repulsion degree between the second magnetic circuit system 1222 and the first magnetic circuit system 1212, and enhance the magnetic flux density at the first coil or the second coil. It is understandable that the magnetic flux density at the first coil refers to an average magnetic flux density of the first coil as a whole. In some other scenarios, the magnetic flux density at the first coil may also refer to a magnetic flux density at a specific point or a plurality of specific points of the first coil. The same applies to the magnetic flux density at the second coil, which is not described again herein.

In some embodiments, please refer to FIG. 16, the first magnetic circuit system 1212 may include a first magnet 1213 for driving the first diaphragm 1211 and a magnetic conduction cover 1214 disposed around the first magnet 1213. A side of the first diaphragm 1211 facing the first magnetic circuit system 1212 is acoustically coupled with other acoustic holes (e.g., the pressure relief hole 1104) on the core housing 11 to form the first rear cavity 1202. A side of the first diaphragm 1211 away from the first magnetic circuit system 1212 is acoustically coupled with the first sound outlet 1101 to form the first front cavity 1201. The second magnetic circuit system 1222 may include a second magnet 1223 for driving the second diaphragm 1221 to produce a sound. A side of the second diaphragm 1221 facing the second magnetic circuit system 1222 is defined as the second rear cavity 1204. A side of the second diaphragm 1221 away from the second magnetic circuit system 1222 is acoustically coupled with the second sound outlet 1102 to form the second front cavity 1203.

The aforementioned arrangement that the first magnetic circuit system 1212 and the second magnetic circuit system 1222 repel each other may indicate that magnetic poles of the second magnet 1223 and the first magnet 1213 are arranged to repel each other. In some embodiments, please refer to FIG. 16, a magnetic pole of the second magnet 1223 facing the first magnet 1213 is an N pole, and a magnetic pole of the first magnet 1213 facing the second magnet 1223 is also an N pole. In this case, the magnetic poles of the first magnet 1213 and the second magnet 1223 are arranged to repel each other. In some embodiments, the magnetic pole of the second magnet 1223 facing the first magnet 1213 is an S pole, and the magnetic pole of the first magnet 1213 facing the second magnet 1223 is an S pole. In this case, the magnetic poles of the first magnet 1213 and the second magnet 1223 are also arranged to repel each other.

In some embodiments, in a first reference plane perpendicular to the vibration direction of the second diaphragm 1221, the second magnet 1223 at least partially overlaps with the first magnet 1213. The repulsion degree may be adjusted by adjusting an overlapping portion between the second magnet 1223 and the first magnet 1213, thereby achieving adjustment of the sound pressure level or volume of the headphone 100.

In some embodiments, the second magnetic circuit system 1222 may include a third magnet 1224 cooperating with the second magnet 1223 to drive the second diaphragm 1221 to produce a sound. The second magnet 1223 and the third magnet 1224 cooperate to drive the second diaphragm 1221 to produce the sound, thereby enhancing the acoustic performance of the second speaker 122.

The third magnet 1224 may be disposed around the second magnet 1223 and located on the same side of the second diaphragm 1221 as the second magnet 1223. In some embodiments, along the vibration direction of the second diaphragm 1221, a magnetic pole of the side of the third magnet 1224 facing the second diaphragm 1221 is opposite to the magnetic pole of the side of the second magnet 1223 facing the second diaphragm 1221. That is, the magnetic poles of the second magnet 1223 and the third magnet 1224 are oriented in opposite directions along the vibration direction of the second diaphragm 1221. For example, the magnetic pole of the side of the third magnet 1224 facing the second diaphragm 1221 is an N pole, a magnetic pole of a side of the third magnet 1224 away from the second diaphragm 1221 is an S pole, a magnetic pole of a side of the second magnet 1223 facing the second diaphragm 1221 is an S pole, and a magnetic pole of a side of the second magnet 1223 away from the second diaphragm 1221 is an N pole. As another example, the magnetic pole of the side of the third magnet 1224 facing the second diaphragm 1221 is an S pole, the magnetic pole of the side of the third magnet 1224 away from the second diaphragm 1221 is an N pole, the magnetic pole of the side of the second magnet 1223 facing the second diaphragm 1221 is an N pole, and the magnetic pole of the side of the second magnet 1223 away from the second diaphragm 1221 is an S pole.

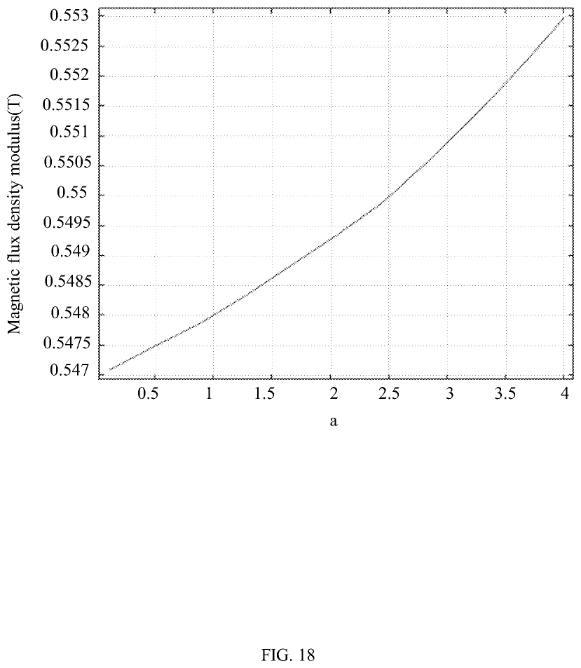

Please refer to FIG. 17 and FIG. 18, FIG. 17 is a schematic diagram illustrating cooperation between the second magnet 1223, the third magnet 1224, and the first speaker 121 according to some embodiments of the present disclosure. FIG. 18 is a schematic diagram illustrating an influence of a ratio of a cross-sectional area of the second magnet 1223 perpendicular to the vibration direction of the second diaphragm 1221 to a cross-sectional area of the third magnet 1224 perpendicular to the vibration direction of the second diaphragm 1221 on the magnetic flux density at the first coil in FIG. 17.

In FIG. 17(a), the cross-sectional area of the second magnet 1223 perpendicular to the vibration direction of the second diaphragm 1221 is relatively small compared to the cross-sectional area of the third magnet 1224 perpendicular to the vibration direction of the second diaphragm 1221, accounting for about 10% of the cross-sectional area of the third magnet 1224 perpendicular to the vibration direction of the second diaphragm 1221. In FIG. 17(b), the cross-sectional area of the second magnet 1223 perpendicular to the vibration direction of the second diaphragm 1221 is relatively large compared to the cross-sectional area of the third magnet 1224 perpendicular to the vibration direction of the second diaphragm 1221, about 4 times the cross-sectional area of the third magnet 1224 perpendicular to the vibration direction of the second diaphragm 1221. In FIG. 18, the ratio of the cross-sectional area of the second magnet 1223 perpendicular to the vibration direction of the second diaphragm 1221 to the cross-sectional area of the third magnet 1224 perpendicular to the vibration direction of the second diaphragm 1221 is used as a horizontal coordinate, and the magnetic flux density at the first coil is used as a vertical coordinate. In the first reference plane perpendicular to the vibration direction of the second diaphragm 1221, it may be seen that as the ratio of the cross-sectional area of the second magnet 1223 to the cross-sectional area of the third magnet 1224 gradually increases from 0.1 to 4, and the magnetic flux density at the first coil also increases. Thus, it may be concluded that as the ratio of the cross-sectional area of the second magnet 1223 to the cross-sectional area of the third magnet 1224 increases, a combined magnetic field of the second speaker 122 (e.g., a magnetic field resulting from coupling of magnetic fields generated by the second magnet 1223 and the third magnet 1224) continuously enhances the magnetic flux density at the first coil, thereby improving the sensitivity of the first speaker 121.

In some embodiments, to improve the sensitivity of the first speaker 121 while ensuring an acoustic output performance of the second speaker 122, the ratio of the cross-sectional area of the second magnet 1223 perpendicular to the vibration direction of the second diaphragm 1221 to the cross-sectional area of the third magnet 1224 perpendicular to the vibration direction of the second diaphragm 1221 is in a range of 0.5-4. In some embodiments, to improve the sensitivity of the first speaker 121 while ensuring the acoustic output performance of the second speaker 122, the ratio of the cross-sectional area of the second magnet 1223 perpendicular to the vibration direction of the second diaphragm 1221 to the cross-sectional area of the third magnet 1224 perpendicular to the vibration direction of the second diaphragm 1221 is in a range of 1-2.5. In some embodiments, to improve the sensitivity of the first speaker 121 while ensuring the acoustic output performance of the second speaker 122, the ratio of the cross-sectional area of the second magnet 1223 perpendicular to the vibration direction of the second diaphragm 1221 to the cross-sectional area of the third magnet 1224 perpendicular to the vibration direction of the second diaphragm 1221 is in a range of 2-3.

In some embodiments, in the first reference plane perpendicular to the vibration direction of the second diaphragm 1221, an overlapping area between the second magnet 1223 and the first magnetic circuit system 1212 (e.g., the first magnet 1213) is greater than an overlapping area between the third magnet 1224 and the first magnetic circuit system 1212 (e.g., the first magnet 1213). The arrangement ensures an area over which the second magnet 1223 affects the first magnetic circuit system 1212 (e.g., the first magnet 1213), thereby enhancing the repulsion degree between the second magnetic circuit system 1222 and the first magnetic circuit system 1212. In some embodiments, in the first reference plane perpendicular to the vibration direction of the second diaphragm 1221, the overlapping area between the second magnet 1223 and the first magnetic circuit system 1212 (e.g., the first magnet 1213) is not less than 90% of an area of the second magnet 1223. In some embodiments, in the first reference plane perpendicular to the vibration direction of the second diaphragm 1221, the overlapping area between the second magnet 1223 and the first magnetic circuit system 1212 (e.g., the first magnet 1213) is 100% of the area of the second magnet 1223.

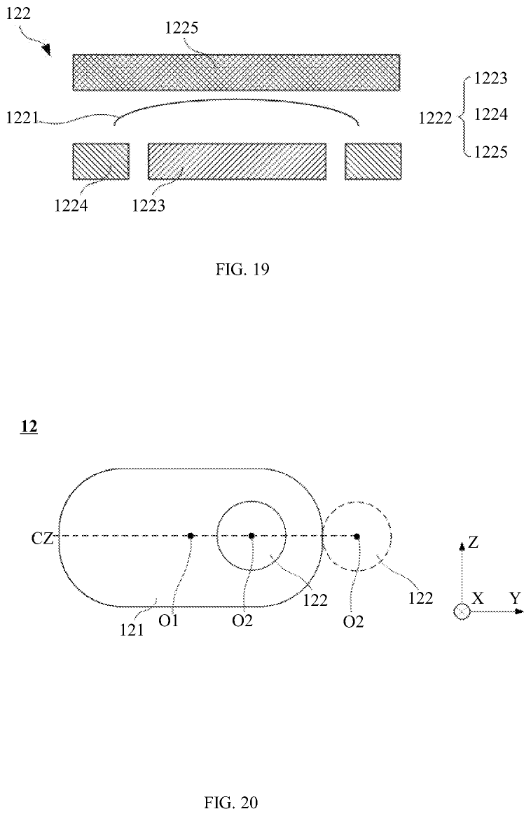

Please refer to FIG. 19, FIG. 19 is a schematic diagram illustrating the second speaker 122 in FIG. 17 according to some embodiments of the present disclosure. The second magnetic circuit system 1222 may include a fourth magnet 1225 cooperating with the second magnet 1223 to drive the second diaphragm 1221 to produce a sound. The fourth magnet 1225 may cooperate with the second magnet 1223 to drive the second diaphragm 1221 to produce the sound, thereby enhancing the acoustic performance of the second speaker 122. In some embodiments, the fourth magnet 1225 cooperates with the second magnet 1223 and the third magnet 1224 to drive the second diaphragm 1221 to produce the sound, thereby enhancing the acoustic performance of the second speaker 122.

The fourth magnet 1225 may be located on the side of the second diaphragm 1221 away from the second magnet 1223. That is, the fourth magnet 1225 and the second magnet 1223 are located on opposite sides of the second diaphragm 1221. In some embodiments, a magnetic pole of a side of the fourth magnet 1225 facing the second diaphragm 1221 is the same as the magnetic pole of the side of the second magnet 1223 facing the second diaphragm 1221. For example, the magnetic pole of the side of the fourth magnet 1225 facing the second diaphragm 1221 is an N pole, and the magnetic pole of the side of the second magnet 1223 facing the second diaphragm 1221 is an N pole. As another example, the magnetic pole of the side of the fourth magnet 1225 facing the second diaphragm 1221 is an S pole, and the magnetic pole of the side of the second magnet 1223 facing the second diaphragm 1221 is an S pole. The arrangement may further increase the magnetic flux density at the second coil of the second speaker 122, thereby enhancing the output sound pressure level of the second speaker 122.

In some embodiments, a projection of the second speaker 122 along the vibration direction of the second diaphragm 1221 may entirely fall within the first speaker 121. In some embodiments, a projection of the second speaker 122 along the vibration direction of the first diaphragm 1211 may entirely fall within the first speaker 121. The arrangement ensures the repulsion degree between the first magnetic circuit system 1212 and the second magnetic circuit system 1222, while making an internal space of the headphone more compact and improving space utilization.

Please refer to FIG. 13, in a second reference plane perpendicular to the vibration direction of the first diaphragm 1211, the first magnetic circuit system 1212 includes a long-axis direction CZ and a short-axis direction DZ that are orthogonal to each other. The dimension of the first magnetic circuit system 1212 along the long-axis direction CZ is greater than a dimension of the first magnetic circuit system 1212 along the short-axis direction DZ. In some embodiments, the long-axis direction CZ may be the longitudinal direction Y of the core housing 11, i.e., a direction in which the connection end CE and the free end FE are spaced apart. The short-axis direction DZ may be the width direction Z of the core housing 11. In other embodiments, the long-axis direction CZ may also intersect the longitudinal direction Y of the core housing 11, and the short-axis direction DZ may also intersect the width direction Z of the core housing 11.

In some embodiments, the second speaker 122 may be centrally disposed relative to the first speaker 121 along the short-axis direction DZ. In the second reference plane, the first speaker 121 includes a center O1, and the second speaker 122 includes a center O2. It may be understood that centrally disposed may be defined as a distance between the center O1 and the center O2 along the short-axis direction DZ being no greater than 10% of the dimension of the first speaker 121 along the short-axis direction DZ. In some embodiments, the distance between the center O1 and the center O2 along the short-axis direction DZ is 0.

Please refer to FIG. 13, an axial direction of the second speaker 122 may be parallel to an axial direction of the first speaker 121. That is, an angle between the axial direction of the second speaker 122 and the axial direction of the first speaker 121 is 0°, indicating a consistent relative orientation between the first speaker 121 and the second speaker 122. When the second speaker 122 moves relative to the first speaker 121 along the long-axis direction CZ of the first speaker 121, an overlapping area between the second speaker 122 and the first speaker 121 in the axial direction of the first speaker 121 increases. The arrangement gradually enhances a repulsive force between the second magnetic circuit system 1222 and the first magnetic circuit system 1212, thereby gradually increasing the sound pressure level of the sound radiated by the first speaker 121 or the second speaker 122.

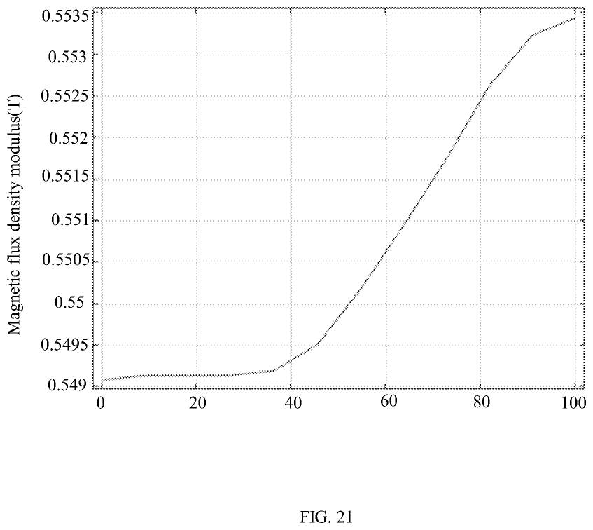

Please refer to FIG. 20 and FIG. 21, FIG. 20 is a schematic diagram illustrating the second speaker 122 in FIG. 13 when moving in the long-axis direction CZ. FIG. 21 is a schematic diagram illustrating an influence of movement of the second speaker 122 in FIG. 20 in the long-axis direction CZ on the magnetic flux density at the first coil. In FIG. 21, a horizontal coordinate represents a movement distance of the second speaker 122 along the long-axis direction CZ, and a vertical coordinate represents the magnetic flux density at the first coil. A starting point of a movement process of the second speaker 122 is a position where, in the axial direction of the first speaker 121, a projection of the second speaker 122 is closest to a projection of the first speaker 121 with an overlapping area of 0, i.e., a position of the second speaker 122 indicated by a dashed line in FIG. 20. An ending point is a position where the center O1 of the first speaker 121 coincides with the center O2 of the second speaker 122, i.e., a position of the center O1 at a left side of the second speaker 122 indicated by a solid line in FIG. 20. Referring to FIG. 21, it may be seen that when the second speaker 122 moves relative to the first speaker 121 along the long-axis direction CZ of the first speaker 121, the magnetic flux density at the first coil increases as the movement distance increases. The discovery indicates that a relative positional relationship between the first speaker 121 and the second speaker 122 along the long-axis direction CZ affects the magnetic flux density at the first coil of the first speaker 121. When the center O1 of the first speaker 121 and the center O2 of the second speaker 122 gradually approach each other along the long-axis direction CZ, the overlapping area between the second speaker 122 and the first speaker 121 in the axial direction of the first speaker 121 increases, which gradually enhances the repulsive force between the second magnetic circuit system 1222 and the first magnetic circuit system 1212, thereby improving the sensitivity of the first speaker 121.

In some embodiments, please refer to FIG. 13, in the long-axis direction CZ, a distance between the center O1 of the first speaker 121 and the center O2 of the second speaker 122 does not exceed 5 mm. The arrangement ensures the enhancement effect of the second speaker 122 on the magnetic flux density at the first coil of the first speaker 121, thereby improving the output sound pressure level of the first speaker 121. In some embodiments, in the long-axis direction CZ, the distance between the center O1 of the first speaker 121 and the center O2 of the second speaker 122 does not exceed 4.5 mm.

In some embodiments, please refer to FIG. 13, in the long-axis direction CZ, a ratio of the distance between the center O1 of the first speaker 121 and the center O2 of the second speaker 122 to a dimension of the first speaker 121 along the long-axis direction CZ does not exceed 0.3. In some embodiments, in the long-axis direction CZ, the ratio of the distance between the center O1 of the first speaker 121 and the center O2 of the second speaker 122 to the dimension of the first speaker 121 along the long-axis direction CZ does not exceed 0.25. The arrangement ensures the enhancement effect of the second speaker 122 on the magnetic flux density at the first coil of the first speaker 121, thereby improving the output sound pressure level of the first speaker 121.

In some embodiments, in the long-axis direction CZ, a maximum distance from the center O2 of the second speaker 122 to the outer end surface RS of the free end FE does not exceed 10 mm. The arrangement enables the second speaker 122 to be closer to the free end FE of the core housing 11 in the wearing state (e.g., the state where the free end FE extends into the concha cavity 2002), making that the sound output from the second sound outlet 1102 can be better transmitted to the ear canal of the user, thereby increasing the listening volume. In some embodiments, in the long-axis direction CZ, the maximum distance from the center O2 of the second speaker 122 to the outer end surface RS of the free end FE does not exceed 8 mm. It may be understood that when the free end FE is an arc surface, a point on the arc surface farthest from the connection end CE along the longitudinal direction Y is located on a cross-section perpendicular to the longitudinal direction Y, and a maximum distance from the center O2 to the cross-section does not exceed 8 mm.

In some embodiments, in the long-axis direction CZ, the first magnetic circuit system 1212 includes a first reference point C1 that is closest to the free end FE. The second magnetic circuit system 1222 includes a second reference point C2 that is closest to the free end FE. The second reference point C2 is located on a side of the first reference point C1 away from the free end FE. In some embodiments, a distance M between the first reference point C1 and the second reference point C2 is greater than or equal to 3 mm, to ensure the repulsion degree between the second magnetic circuit system 1222 and the first magnetic circuit system 1212, thereby improving the output sound pressure levels of the first speaker 121 and the second speaker 122. In some embodiments, in the long-axis direction CZ, a maximum distance from the center O2 of the second speaker 122 to a point of the first speaker 121 away from the second speaker 122 is less than or equal to 5 mm.

In some other embodiments of the present disclosure, the axial direction of the second speaker 122 may also be adjusted, to make an angle between the axial direction of the second speaker 122 and the axial direction of the first speaker 121 be in a range of 0°-90°. As another example, the angle between the axial direction of the second speaker 122 and the axial direction of the first speaker 121 may be equal to 90°. It is understandable that, during a process of adjusting the axial direction of the second speaker 122, adjustment of the repulsive force between the second magnetic circuit system 1222 and the first magnetic circuit system 1212 is also achieved.

Referring to FIG. 6 and FIG. 7, the main control circuit board 13 may be connected to the second housing 112, for example, fixed to a heat stake column connected to the top wall 1121, and may partially overlap with the second side wall 1122 in the thickness direction X to facilitate the arrangement of a sufficiently large first speaker 121 within the core housing 11, thereby enhancing the sound volume generated by the headphone 100, i.e., optimizing the layout and improving space utilization. In some embodiments, the main control circuit board 13 may not overlap with the second side wall 1122 in the thickness direction X. In some embodiments, a thickness direction of the main control circuit board 13 may be the thickness direction X. In some embodiments, the thickness direction of the main control circuit board 13 may intersect with the thickness direction X.

Since the main control circuit board 13 is disposed within the core housing 11, for example, the main control circuit board 13 is connected to the second housing 112 (e.g., the top wall 1121), the main control circuit board 13 may be electrically connected to other electronic components or external devices via elastic metal components such as pogo pins or metal springs.

In some embodiments, the main control circuit board 13 is located on a side of the first speaker 121 close to the second housing 112. In some embodiments, the main control circuit board 13 and the first speaker 121 may be stacked along the thickness direction of the main control circuit board 13 or along the axial direction of the first speaker 121. In some embodiments, along the axial direction of the first speaker 121, the main control circuit board 13 may overlap with a portion of the first speaker 121 close to the connection end CE, thereby optimizing the layout and improving space utilization.

Referring to FIG. 14, the main control circuit board 13 may be electrically connected to connection ends (e.g., the first connection end 1301, the second connection end 1302, and other connection ends) to achieve control of the speaker assembly 12. In some embodiments, the connection ends (e.g., the first connection end 1301, the second connection end 1302, and other connection ends) may be located on the main control circuit board 13.

A driving circuit 131 may be disposed on the main control circuit board 13 to drive the speaker assembly 12 (e.g., the first speaker 121 and the second speaker 122). Furthermore, the driving circuit 131 may primarily include a digital-to-analog conversion circuit 1311. The driving circuit 131 may also include a power amplification circuit, a processor, etc. Specifically, the driving circuit 131 may be formed using at least the digital-to-analog conversion circuit 1311 and other circuits according to existing techniques in the art, which will not be elaborated here.

The driving circuit 131 may be electrically connected to the connection ends (e.g., the first connection end 1301, the second connection end 1302, and other connection ends), thereby achieving electrical connection with the speaker assembly 12 (e.g., the first speaker 121 and the second speaker 122) to drive the speaker assembly 12 (e.g., the first speaker 121 and the second speaker 122).

In some embodiments, the driving circuit 131 may drive both the first speaker 121 and the second speaker 122 simultaneously via a single digital-to-analog conversion circuit 1311, thereby simplifying the circuit configuration and reducing costs. That is, the driving circuit 131 may be configured to drive both the first speaker 121 and the second speaker 122 simultaneously via the same digital-to-analog conversion circuit 1311. Furthermore, when the first speaker 121 and the second speaker 122 operate in coordination, the first resonant frequency of the first front cavity 1201 may be utilized to attenuate the sound waves within the high frequency band generated by the first speaker 121, after which the second speaker 122 effectively supplements additional sound waves within the high frequency band without affecting the overall sound quality.

It is understandable that the headphone 100 may also include electronic components that ensure normal operation of the headphone 100, such as a battery, a sensor, an antenna, etc. The electronic components may be disposed in at least one of the core module 10 or the ear hook 20 as needed, which will not be elaborated here.

In some embodiments provided in the present disclosure, it should be understood that the disclosed method and device may be implemented in other manners. For example, the device embodiments described above are merely illustrative. For example, the division of modules or units is merely a division based on logical functions. In actual implementation, there may be other division manners. For example, a plurality of units or assemblies may be combined or integrated into another system, or some features may be omitted or not executed.

The units described as separate components may be or not be physically separate. The components displayed as units may be or not be physical units. That is, the units and the components may be located in one place or may be distributed over a plurality of network units. Some or all of the units may be selected according to actual needs to achieve the objectives of the embodiments.

In addition, the functional units in the various embodiments of the present disclosure may be integrated into one processing unit, or each unit may exist alone physically, or two or more units may be integrated into one unit. The above integrated units may be implemented in the form of hardware or may be implemented in the form of software functional units.

The foregoing descriptions are merely specific embodiments of the present disclosure. However, the protection scope of the present disclosure is not limited thereto. Any person skilled in the art can readily conceive of changes or substitutions within the technical scope disclosed in the present disclosure. These changes or substitutions shall fall within the protection scope of the present disclosure. Therefore, the protection scope of the present disclosure shall be subject to the protection scope of the claims.

What is claimed is:

1. A headphone, comprising: a first speaker and a second speaker, wherein
a frequency band of a sound output by the first speaker is at least partially lower than a frequency band of a sound output by the second speaker,
the first speaker includes a first diaphragm and a first magnetic circuit system configured to drive the first diaphragm to produce the sound output by the first speaker,
the second speaker includes a second diaphragm and a second magnetic circuit system configured to drive the second diaphragm to produce the sound output by the second speaker, wherein
a projection of the first magnetic circuit system in a vibration direction of the first diaphragm at least partially overlaps with a projection of the second magnetic circuit system in the vibration direction of the first diaphragm, and
the second magnetic circuit system and the first magnetic circuit system are arranged to repel each other.

2. The headphone of claim 1, comprising:
a core module and an ear hook connected to the core module, wherein in a wearing state, the core module is located on a front side of an ear of a user and at least a portion of the ear hook is located on a rear side of the ear to make the headphone hang on the ear.

3. The headphone of claim 2, wherein the core module is configured so as not to block an ear canal of the ear in the wearing state.

4. The headphone of claim 2, wherein the core module includes a core housing and a main control circuit board, wherein the main control circuit board, the first speaker, and the second speaker are disposed in the core housing.

5. The headphone of claim 4, wherein
the first speaker is disposed within the core housing and cooperates with the core housing to form a first front cavity located at a front side of the first diaphragm and a first rear cavity located at a rear side of the first diaphragm; and
the second speaker is disposed within the core housing, the second speaker is located in the first front cavity of the first speaker, wherein an axial direction of the first speaker is parallel to an axial direction of the second speaker.

6. The headphone of claim 1, wherein a projection of the second magnetic circuit system in a vibration direction of the second diaphragm at least partially overlaps with a projection of the first magnetic circuit system in the vibration direction of the second diaphragm.

7. The headphone of claim 1, wherein the first magnetic circuit system includes a first magnet and a magnetic conduction housing surrounding the first magnet, the second magnetic circuit system includes a second magnet and a third magnet surrounding the second magnet, and a magnetic pole of the second magnet and a magnetic pole of the third magnet are opposite to each other in a vibration direction of the second diaphragm, wherein
within a first reference plane perpendicular to the vibration direction of the second diaphragm, an overlap area between a projection of the second magnet and a projection of the first magnet is not less than 90% of an area of the second magnet.

8. The headphone of claim 7, wherein within the first reference plane,
an area of the projection of the second magnet is greater than an area of a projection of the third magnet,
the overlap area between the projection of the second magnet and the projection of the first magnet is greater than an overlap area between the projection of the third magnet and the projection of the first magnet, and
a magnetic pole of the first magnet and the magnetic pole of the second magnet are arranged to repel each other.

9. The headphone of claim 8, wherein within a second reference plane perpendicular to the vibration direction of the first diaphragm, the first magnetic circuit system has a long-axis direction and a short-axis direction orthogonal to each other, a dimension of the first magnetic circuit system in the long-axis direction is greater than a dimension of the first magnetic circuit system in the short-axis direction;
wherein the second speaker is centered relative to the first speaker in the short-axis direction.

10. The headphone of claim 9, wherein in the long-axis direction, a distance between a center of the first speaker and a center of the second speaker does not exceed 5 mm.

11. The headphone of claim 2, wherein the core module includes a core housing, and the core housing is connected to the ear hook, the core housing has a connection end connected to the ear hook and a free end away from the ear hook,
in a wearing state, the free end extends into or covers a concha cavity, and the second speaker is close to the free end.

12. The headphone of claim 11, wherein the free end extends into the concha cavity in the wearing state, and in a long-axis direction, a maximum distance from the center of the second speaker to an outer end surface of the free end does not exceed 10 mm, the long-axis direction is arranged in a direction in which the connection end and the free end are spaced apart.

13. The headphone of claim 1, wherein a projection of the second speaker in a vibration direction of the second diaphragm entirely falls within a projection of the first speaker in the vibration direction of the second diaphragm.

14. The headphone of claim 2, wherein the core module includes an inner side surface facing the ear along a thickness direction of the core module, an outer side surface facing away from the ear, and connecting surfaces connecting the inner side surface and the outer side surface in the wearing state.

15. The headphone of claim 14, wherein the inner side surface is provided with a first sound outlet, and the first speaker outputs the sound through the first sound outlet.

16. The headphone of claim 15, wherein the inner side surface is provided with a protruding portion protruding in the thickness direction, and the first sound outlet is on the protruding portion.

17. The headphone of claim 15, wherein the inner side surface is provided with a protruding portion protruding in the thickness direction, the first sound outlet is disposed to surround a periphery of the protruding portion.

18. The headphone of claim 15, wherein the inner side surface is provided with a second outlet, on a plane perpendicular to the thickness direction, a shortest distance between a hole edge of an orthographic projection of the second sound outlet and a hole edge of an orthographic projection of the first sound outlet is not less than 2 mm.

19. The headphone of claim 1, wherein a repulsion degree between the second magnetic circuit system and the first magnetic circuit system is configured such that a sound pressure level of at least one of the first speaker or the second speaker is increased by at least 1 dB compared to a sound pressure level when the first speaker or the second speaker operates alone.

20. The headphone of claim 1, wherein the first speaker cooperates with the core housing to form a first front cavity located at a front side of the first diaphragm and a first rear cavity located at a rear side of the first diaphragm,
wherein the first front cavity includes a first resonant frequency, the first rear cavity includes a second resonant frequency, the second speaker includes a third resonant frequency, and a difference between the third resonant frequency and the first resonant frequency and a difference between the third resonant frequency and the second resonant frequency are not less than 2000 Hz.
